(19) United States
(12) Patent Application Publication
(10) Pub. No.: US 2025/0353488 A1
(43) Pub. Date: Nov. 20, 2025

(54) DYNAMIC PARKING LOCATION DETERMINING MANAGEMENT

(71) Applicant: Zoox, Inc., Foster City, CA (US)

(72) Inventors: Oytun Ulutan, Buena Park, CA (US); Rasmus Fonseca, Boulder Creek, CA (US); Jeffrey Loris Irion, Castro Valley, CA (US); Derek Xiang Ma, San Carlos, CA (US); Arunabh Mishra, Brookline, MA (US); Daniel Casey Mox, San Francisco, CA (US); Glen Thomas Neville, Medford, MA (US); Steven Cheng Qian, San Francisco, CA (US); Hang Ren, Westbury, NY (US)

(21) Appl. No.: 18/667,912

(22) Filed: May 17, 2024

(51) Int. Cl. B60W 30/06; G01C 21/00; G06N 20/00

(52) U.S. Cl. CPC B60W 30/06; G01C 21/3811; G06N 20/00; B60W 2420/403; B60W 2420/408; B60W 2552/53; B60W 2554/4042; B60W 2556/40

(57) ABSTRACT

Techniques for determining drivable area(s), parking location(s), or other incident areas in an environment are discussed herein. The drivable area(s), parking location(s), and/or other incident areas can be determined by a machine learned model. Training of the machine learned model can be based on sensor data and map data. The sensor data and the map data can be utilized to determine a representation (e.g., a top-down representation) of an environment. The representation can include at least road marking and velocity information associated with a dynamic object in the environment. The sensor data can be utilized to determine the dynamic object. The machine learned model can generate outputs including probabilities that elements of the outputs represent a drivable area, non-drivable area, a parking location, and/or an incident area. The outputs can be utilized to generate a trajectory. The trajectory can be utilized to control a vehicle to traverse the environment.

### BACKGROUND

Machine learned models can be employed to predict an action for a variety of robotic devices. For instance, planning systems in autonomous and semi-autonomous vehicles determine actions for a vehicle to take in an operating environment. Actions for a vehicle may be determined based in part on avoiding objects present in the environment. For example, an action may be generated to yield to a pedestrian, to change a lane to avoid another vehicle in the road, or the like. Accurately predicting future object trajectories (and drivable areas in an environment where a trajectory may traverse) may be necessary to safely operate the vehicle in the vicinity of the objects.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIGS. 1A and 1B are flowcharts depicting example processes for dynamic drivable area determining management.

FIGS. 2A and 2B are example architectures for implementing dynamic drivable area determinations.

FIGS. 3A and 3B depict example environments including construction zones and parking destination map areas.

FIGS. 4A and 4B depict example environments including, respectively, a dynamic object near a construction zone not to be followed by a vehicle based on the observed attributes, and oncoming objects located in a lane in a construction zone previous utilized for same direction traffic.

FIG. 5 illustrates an example computing environment that may be used to implement the dynamic drivable area determining management systems, in accordance with one or more examples of the disclosure.

FIG. 6 depicts an example process for dynamic drivable area determining management.

### DETAILED DESCRIPTION

This application describes techniques for determining a dynamic drivable area. Drivable areas can be determined by machine learned models. The machine learned models can generate outputs including probabilities that elements of the outputs represent the drivable areas and non-drivable areas in environments. In some examples, the machine learned models can generate outputs including probabilities that elements of the outputs represent parking locations or drivable areas in an environment. The outputs can be utilized to generate trajectories, which can in turn be utilized to control vehicles traversing the environments. Training of the machine learned models can be based on sensor data and map data. The sensor data and the map data can be utilized to determine representations of the environments, such as top-down representations. The top-down representations can include at least road marking and velocity information associated with dynamic objects in the environments. The sensor data can be utilized to determine the dynamic objects.

The vehicles can be controlled based on various types of areas. The areas can include construction zones, parking destination map areas, and/or other incident areas. The construction zones can be identified based on various types of construction objects. The construction objects can include dividers, cones, and so on, or any combination thereof. The parking area destination map areas can include curbs, lane markings, and so on, or any combination thereof. Examples of other incident areas include, but are not limited to, areas defined by police tape or caution tape, areas associated with an emergency (e.g., ambulance, fire, police, etc.), areas defined by temporary barriers (e.g., protests, parades, bike/foot races, etc.), and the like.

The top-down representation can include a multi-channel image or polylines, which can be input into a machine learned model. The machine learned model can analyze the top-down representation to generate outputs utilized to identify drivable or non-drivable areas. The multi-channel image can include rasterized image data. For example, the rasterized image data can include pixels and/or picture elements that include unique colors and tonal characteristics that are combinable together to create an image, including the top-down representation. In some examples, different semantic data can be presented in different channels or layers of the multi-channel image. The polylines can be as vectorized image data. The polylines can include scalable vector graphics (SVG) shapes that create lines (straight or otherwise) connecting several points.

The machine learned models can be trained based on vehicle data captured as the vehicles traverse the environments. Data associated with the environments can be collected based on input to sensors of the vehicles. The data can include perception data that is utilized to identify previous road marking and velocity information. The previous road marking and velocity information can include velocity information associated with objects in the environment. The velocity information can include velocity data, such as a speed, a direction, etc., associated with the objects. The perception data can be identified based on sensor data collected by the vehicles. The sensor data can include data that is more current and/or accurate than map data received by the vehicles. For example, the sensor data can include actual data indicating and/or representing locations, characteristics, identities, etc., or any combination thereof, of objects in the construction zones and parking destination map areas.

The dynamic drivable area determining management techniques described herein can improve a functioning of a computing device by providing drivable area and non-drivable area data for performing operations to control an autonomous vehicle (or other system). For example, drivable areas and non-drivable areas can be identified based on dynamically generated data. The dynamically determined drivable areas and non-drivable areas can be identified and utilized as part of subsequent processes such as localization, perception (e.g., detecting, identifying, segmenting, classifying, tracking, etc.), route planning, trajectory generation, and the like. By utilizing the dynamic data, the processes can be performed more accurately, with consumption of less processing power, and/or with storage in relatively smaller amounts of memory.

For example, in some instances, faster and/or more accurate drivable area determination can be used in generating a trajectory of an autonomous vehicle, which can improve safety for occupants of an autonomous vehicle. Further, in some examples, the techniques discussed herein can be used to verify a calibration of sensors, can provide error checking or voting to determine if a sensor measurement is inaccurate (e.g., by comparing a depth measurement to another depth sensor), and/or can be used as a fallback in the event other sensors are occluded or disabled. In some examples, training a machine learned model using such self-supervised and supervised techniques (which together may comprise semi-supervised training) provide for a machine learned model that may output more accurate depth estimates than a model trained without these techniques. These and other improvements to the functioning of the computer are discussed herein.

The techniques described herein can be implemented in a number of ways. Example implementations are provided below with reference to the following figures. Although applicable to vehicles, such as autonomous vehicles, the methods, apparatuses, and systems described herein can be applied to a variety of systems and are not limited to autonomous vehicles. In one example, similar techniques may be utilized in driver controlled vehicles in which such a system may provide an indication of whether it is safe to perform various maneuvers. In another example, the techniques can be utilized in an aviation or nautical context, or in any system configure to input data to determine movement associated with objects in an environment. Additionally, the techniques described herein can be used with real data (e.g., captured using sensor(s)), simulated data (e.g., generated by a simulator), or any third of the two.

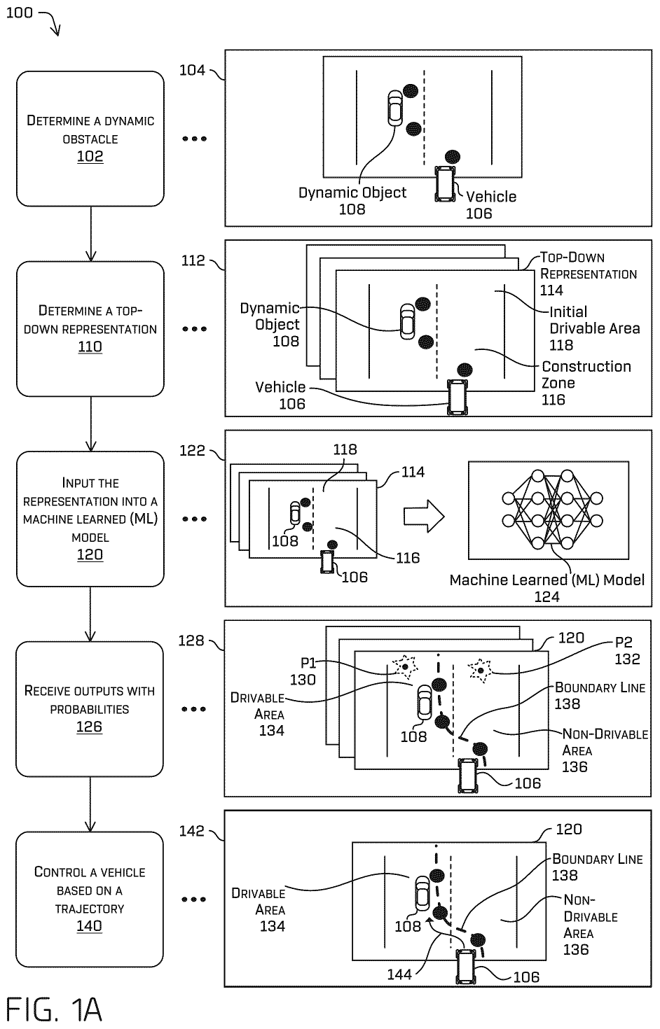

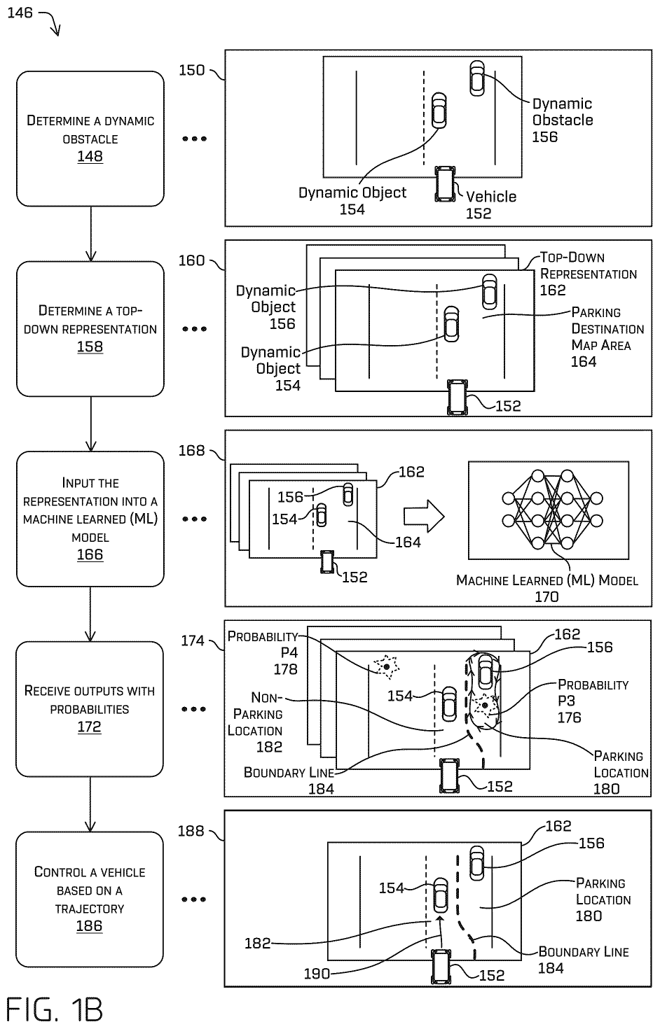

FIGS. 1A and 1B are flowcharts depicting example processes for dynamic drivable area determining management. With respect to FIG. 1A, a process 100 is depicted in a flowchart for dynamic drivable area determining management. At an operation 102, the process 100 can include determining a dynamic object. A vehicle (e.g., the vehicle 106, as discussed below in further detail) receive sensor data and can process the sensor data to determine that a dynamic object is present in the environment. In some examples, the operation 102 can include determining dynamic drivable area determining information (or “dynamic information”) associated with the environment. The dynamic information, for example, may be determined based on the dynamic object. In some examples, a dynamic object may represent one or more dynamic objects.

The dynamic information may include information associated with any portions of the environment being dynamically and/or continually updated. The dynamic information may include any of the vehicles, moving objects, stationary objects, and/or road markings in the environment.

In various examples, a dynamic object may be determined based on sensor data. Determining the dynamic object may include determining the sensor data, and the dynamic object(s) based on the sensor data. The sensor data may include image data (e.g., camera data) and/or depth data (e.g., lidar data). In some examples, the sensor data may include data generated by one or more image sensors (e.g., one or more red-green-blue (RGB) cameras, one or more intensity cameras (greyscale), one or more infrared cameras, one or more ultraviolet cameras, and the like), one or more depth cameras (e.g., RGB D cameras), one or more time-of-flight (ToF) sensors, one or more lidar sensors, one or more radar sensors, one or more sonar sensors, and the like.

An example 104 illustrates a portion of an environment including one or more vehicles, such as a vehicle 106. The environment illustrated in example 104 may include one or more dynamic objects, such as a dynamic object 108. The environment may include one or more cones, as represented by circles illustrated in FIG. 1A.

Individual ones of the vehicle(s) may include an autonomous vehicle. Individual ones of the dynamic objects may include a non-autonomous vehicle. However, the disclosure is not limited as such, and individual ones of the vehicle(s) and/or the dynamic objects may include an autonomous vehicle, a semi-autonomous vehicle, or a non-autonomous vehicle.

The vehicle 106 can be controlled to follow a dynamic object (e.g., the dynamic object 108, as discussed below in further detail,) based on the moving velocity of the dynamic object 108 indicating that the dynamic object 108 is following a safe path. Characteristics, such as the velocity, of the dynamic object 108 may be utilized to identify a safe path associated with the dynamic object 108. The safe path may be identified since the dynamic object 108 is likely to proceed at a velocity above a threshold velocity only if the path of the dynamic object 108 is safe.

Various characteristics associated with the dynamic object 108 can be utilized to identify the safe path. For example, one or more characteristics, such as one or more locations, one or more velocities, one or more directionalities of the dynamic object 108 at one or more times, respectively, in the environment, can be utilized to control the vehicle 106. The characteristic(s) may inform a machine learned (ML) model (e.g., the machine learned (ML) model 124, as discussed below) that areas that otherwise would be non-drivable are actually drivable areas.

An operation 110, the process 100 can include determining a top-down representation. The top-down representation can include any portion of the environment. For example, the top-down representation can include one or more zones (or “zone(s)”) (or “area(s)”). The zone(s) may include one or more construction zones. Determining the top-down representation can include determining one or more other zones. A current and/or future location of the dynamic object(s) and/or the vehicle(s) may be in, and/or near, the zone(s).

One or more areas of the environment may be identified as one or more initial drivable areas. The initial drivable area(s) may be identified in the area(s), such as the construction zone(s). The initial drivable area(s) may be identified based on map data and sensor data.

In some examples, the top-down representation may represent one or more top-down representations. In those or other examples, determining the top-down representation can include determining the top-down representation(s), which may include any portion of the environment.

An example 112 illustrates the environment, with the top-down representation(s) that include various portions of the environment. The top-down representation(s) may include the vehicle 106, the dynamic object 108, the zone(s), and/or the area(s). For example, the vehicle can determine, as part of the dynamic information, the top-down representation(s), which can include a top-down representation 114 with the vehicle 106 and the dynamic object 108. In such an example or another example, the zone(s) in the top-down representation 114 may include a construction zone 116.

The top-down representation 114 may include an area (e.g., an initial drivable area) 118 being initially identified as being drivable. The initial drivable area 118 may overlap (e.g., partially or entirely overlap) with the construction zone 116. The initial drivable area 118 may be initially identified, due to data (e.g., the map data and/or the sensor data) being out of date, as an area within the top-down representation 114 that is subsequently identified as being not drivable.

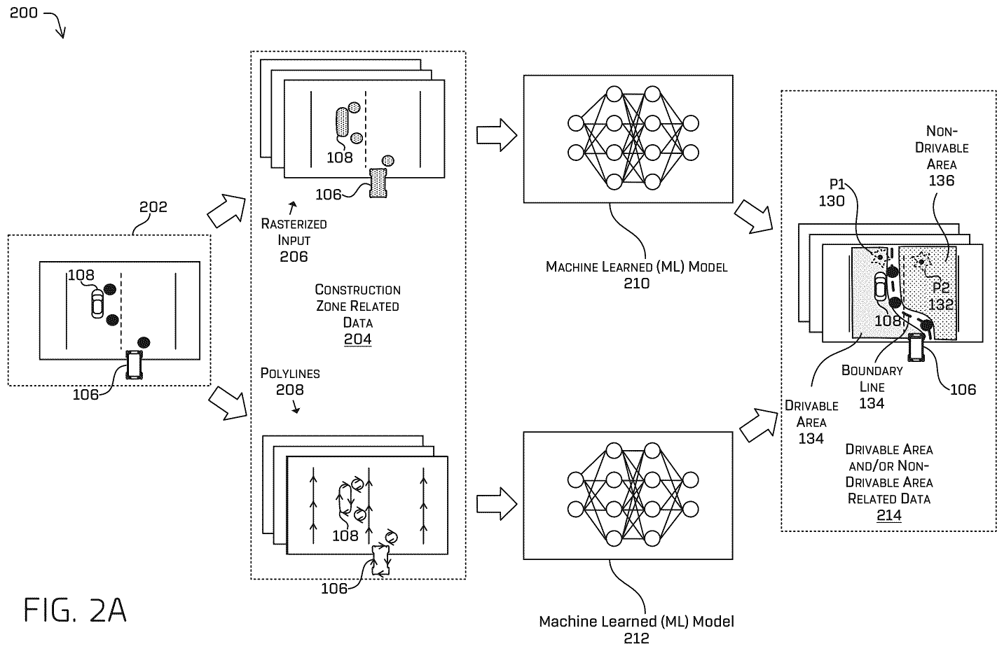

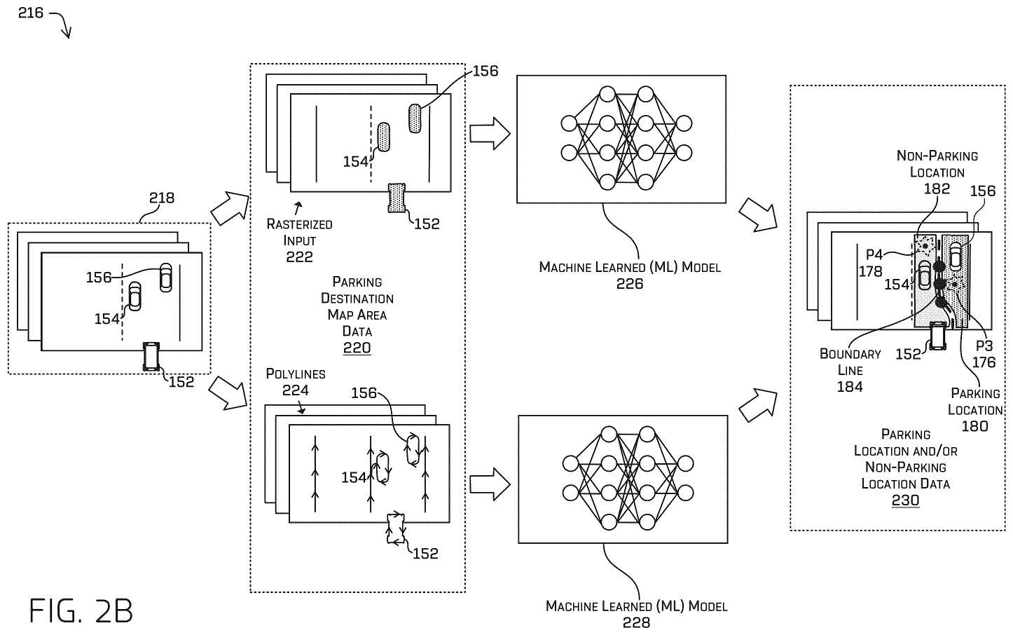

The top-down representation 114 may include different channels, such as different snapshots (e.g., dimensions) associated with different times (e.g., points in time) (e.g., temporal dimensions). The channels may be included in a multi-channel image of multi-channel image data with rasterized input (e.g., the rasterized input 206, as discussed above with reference to FIG. 2A). For example, the temporal dimensions may be represented by a group of rectangles identified by reference numeral 114, as illustrated in FIG. 1.

The dynamic object 108 may move in, and/or near, the zone(s). The dynamic object 108 may move around the construction zone 116. The dynamic object 108 may have a velocity that is above a threshold velocity.

At operation 120, the process 100 can include inputting the top-down representation (or “representation”) into a machine learned (ML) model. Inputting the representation can include inputting, into the ML model, the top-down representation 114 including the vehicle 106, the dynamic object 108, and the construction zone 116.

An example 122 illustrates the environment, with the top-down representation(s) being input into the machine learned (ML) model. The machine learned (ML) model may represent one or more machine learned (ML) models, such as a machine learned model (ML) 124. The top-down representation(s) being input into the machine learned model (ML) 124 can include the top-down representation 114 with the vehicle 106, the dynamic object 108, and the construction zone 116.

At operation 126, the process 100 can include receiving outputs with probabilities. The outputs can include an output with a probability that an element of the output represents a drivable area. The output can include a first output; and the probability can include a first probability that an element of the first output represents the drivable area. The outputs can include an output with a probability that an element of the output represents a non-drivable area. The output can include a second output; and the probability can include a second probability that an element of the second output represents the non-drivable area.

An example 128 illustrates the environment, with one or more probabilities output by the machine learned (ML) model. The vehicle 106 can determine one or more outputs with the probability(ies) that one or more elements of the output(s) represent one or more drivable areas and/or one or more non-drivable areas. The output(s) may be included in the dynamic information.

The probability(ies) can include a probability P1 130, e.g., represented by a star encircling a portion (e.g., a pixel) of the top-down representation (e.g., the top-down representation 114). The probability(ies) can include a probability P2 132, e.g., represented by a star encircling a portion (e.g., a pixel) of the top-down representation 114. The probability P1 130 may be a probability that an element of the output represents a drivable area 134. The probability P2 132 may be a probability that an element of the output represents a non-drivable area 136.

The machine learned (ML) model 124 can output one or more heat maps. For example, a first heat map can include a probability that each individual pixel is a drivable area (e.g., drivable area 134). In such an example or another example, a second heat map can include a probability that each individual pixel is a non-drivable area (e.g., the non-drivable area 136).

In some examples, the output(s) from the machine learned (ML) model 210 can be utilized to identify a boundary line 138. The boundary line 138 can include an outline of the drivable area 134 determined based on the machine learned (ML) model 124 to control the vehicle 106 as, and/or before, the vehicle 106 enters the construction zone 116. The vehicle 106 can be controlled to traverse the drivable area 134 but not the non-drivable area 136.

While the outputs can include the output with the probability(ies) associated with the drivable area 134, as discussed above in the current disclosure, it is not limited as such. In some examples, the probability P1 130 can be utilized to determine at least one of an expanded drivable area (e.g., a drivable area with additional areas in comparison to the initial drivable area 118), or a non-incident area, in a similar way as for the drivable area 134. In some examples, the probability P2 132 can be utilized to determine at least one of an expanded non-drivable area (e.g., a non-drivable area with additional areas in comparison to an initial non-drivable area), or an incident area, in a similar way as for the non-drivable area 136. For instance, the incident area may represent one or more incident areas, including one or more blockades, one or more police blocking cards, one or more flare identified areas, one or more police state areas, one or more motorcades, one or more protestors, and so on, or any combination thereof.

At operation 140, the process 100 can include controlling a vehicle based on a trajectory. The trajectory, which can represent one or more trajectories associated with one or more vehicles, can be determined based on the output of the machine learned (ML) model 124. In some examples, the trajectory(ies) can include a trajectory utilized to control the vehicle (e.g., the vehicle 106). In those or other examples, the trajectory(ies) can include a trajectory utilized to control the vehicle 106.

The vehicle 106 can be controlled to navigate around objects associated with the zone(s) and/or the area(s). In some examples, the vehicle approaching the construction zone can be controlled to navigate through the construction zone, if appropriate, and/or around the construction zone. In those or other examples, the vehicle 106 approaching the construction zone can be controlled to navigate around, in front of, in back or, and/or adjacent to objects that maybe objects, such as cones, dividers, temporary curbs, signs, meters, flaggers, etc., or any combination thereof.

In some examples, controlling of the vehicle 106 can be triggered based on the construction zone information, such as information identifying the construction zone, and/or portions (e.g., cones, dividers, signs, etc.) of the construction zone on a roadway. In alternative or additional examples, controlling of the vehicle 106 can be triggered based on the parking destination map area information, such as information identifying the parking destination map area and/or portions (e.g., temporary curbs, signs, meters, etc.) of the parking destination map area on the roadway. For instance, the controlling of the vehicle 106 can be triggered in response to the identifying of the construction zone information and/or the parking destination map area information, such as by identifying the construction zone and/or the parking destination map area exists in front of the vehicle 106.

The vehicle 106 can be controlled to follow a dynamic object (e.g., the dynamic object 108) based on the moving velocity of the dynamic object 108 indicating that the dynamic object 108 is following a safe path. Characteristics, such as the velocity, associated with the dynamic object 108 may be utilized by the machine learned (ML) model 124 to identify a path of the dynamic object 108 as a safe path. Because the dynamic object 108 is likely to proceed at a velocity above a threshold velocity only if the path of the dynamic object 108 is safe, the machine learned (ML) model 124 can identify an area through which the dynamic object 108 is travelling as the drivable area 134.

An example 142 illustrates the environment, with one or more trajectories being determined based on the probability(ies) output by the machine learned (ML) model 124. The vehicle 106 can determine, as part of the dynamic information, the trajectory(ies). In some examples, the trajectory(ies) can include a trajectory 144 utilized to control the vehicle 106. The vehicle 106 can be controlled based on the dynamic information.

The trajectory 144 can be determined based on the dynamic object 108. The trajectory 144 can be utilized to control the vehicle 106 to follow the dynamic object 108. In those or other examples, the trajectory(ies) can include a trajectory 144 utilized to control the vehicle 106. The trajectory 144 can be utilized to control the vehicle 106. The vehicle 106 can be controlled to follow the dynamic object 108, based on the velocity of the dynamic object 108 being above the threshold velocity.

In some examples, the vehicle 106 can be controlled to follow the dynamic object 108, based on the velocity of the dynamic object 108 being above the threshold velocity and, possibly, based on the velocity of the dynamic object 108 not being above the threshold velocity. In those or other examples, the vehicle 106 can be controlled to follow the dynamic object 108, based on the velocity of the dynamic object 108 being greater than the velocity of one or more other dynamic objects in, for instance, the non-drivable area 136. In those or other examples, the vehicle 106 can be controlled to follow the dynamic object 108, based on a difference between the velocity of the dynamic object 108 and individual velocities of one or more corresponding dynamic objects in the non-drivable area 136 being greater than a threshold difference. In those or other examples, the vehicle 106 can be controlled to follow the dynamic object 108, based on a difference between the velocity of the dynamic object 108 and an average velocity of the individual velocities of the corresponding dynamic object(s) in the non-drivable area 136 being greater than a threshold difference.

With respect to FIG. 1B, a process 146 is depicted in a flowchart for dynamic drivable area determining management. At an operation 148, the process 146 can include determining a dynamic object. A vehicle (e.g., the vehicle 106, as discussed above in further detail, or a similar vehicle) can receive sensor data and map data and process the sensor data and the map data to determine that a dynamic object is present in the environment, in a similar way as for determining the dynamic object at operation 102, as discussed above. In some examples, the operation 148 can include determining dynamic drivable area determining information (or “dynamic information”) associated with the environment. The dynamic information, for example, may be determined based on the dynamic object. In some examples, a dynamic object may represent one or more dynamic objects in one or more areas of the environment.

An example 150 illustrates an environment including one or more vehicles, such as the vehicle 106. The environment illustrated in example 104 may include one or more dynamic objects, such as dynamic objects 154 and 156. The environment that includes the vehicle 152, the dynamic object 154, and the dynamic object 156 may be the same as, or different from the environment that includes the vehicle 106 and the dynamic object 108.

An operation 158, the process 146 can include determining a top-down representation. The top-down representation can include any portion of the environment. For example, the top-down representation can be determined in a similar way as the top-down representation determined according to the operation 110, as discussed above.

An example 160 illustrates the environment, with the top-down representation(s) that include various portions of the environment. The top-down representation(s) may include the vehicle 152, the dynamic object 154, the dynamic object 156, the zone(s), and/or the map area(s). For example, the top-down representation(s) can include a top-down representation 162 with the vehicle 152, the dynamic object 154, the dynamic object 156. The top-down representation 162 may include a parking destination map area 164.

Various characteristics associated with the dynamic object(s) 154 and/or 156 can be utilized to identify the safe path. For example, one or more characteristics, such as one or more locations, one or more velocities, one or more directionalities of the dynamic object(s) 154 and/or 156 at one or more times, respectively, in the environment, can be utilized to control the vehicle 106. The characteristic(s) may inform a machine learned (ML) model (e.g., the machine learned (ML) model 170, as discussed below) that areas that otherwise would be non-parking locations are actually parking locations.

The top-down representation 162 may include different channels, such as different snapshots (e.g., dimensions) associated with different times (e.g., points in time) (e.g., temporal dimensions). The channels may be included in a multi-channel image of multi-channel image data with rasterized input (e.g., the rasterized input 222, as discussed above and below with reference to FIG. 2B). For example, the temporal dimensions may be represented by a group of rectangles identified by reference numeral 162, as illustrated in FIG. 1.

The dynamic object 154 may travel in front of, next to, in back of, etc., parking destination map area 164. The dynamic object 154 may move around the parking destination map area 164. The dynamic object 154 may have a velocity that is above a threshold velocity. The dynamic object 156 may enter, remain in, and/or exit the parking destination area map 164. The dynamic object 156 may have a velocity that is not above a threshold velocity.

At operation 166, the process 146 can include inputting the top-down representation (or “representation”) into a machine learned (ML) model. Inputting the representation can include inputting, into the ML model, the top-down representation 162, which can include the vehicle 152, the dynamic object 154, the dynamic object 156, and the parking destination map area 164.

An example 168 illustrates the environment, with the top-down representation(s) being input into the machine learned (ML) model, such as a machine learned (ML) model 170. The machine learned (ML) model 170 may represent one or more machine learned (ML) models, such as a machine learned model (ML) 170. The top-down representation(s) being input into the machine learned (ML) model 170 can include the top-down representation 162 with the vehicle 152, the dynamic object 154, the dynamic object 156, and the parking destination map area 164.

At operation 172, the process 146 can include receiving outputs with probabilities. The outputs can include an output with a probability that an element of the output represents a parking location. The output can include a first output; and the probability can include a first probability that an element of the first output represents the parking location. The outputs can include an output with a probability that an element of the output represents a non-parking location. The output can include a second output; and the probability can include a second probability that an element of the second output represents the non-parking location.

An example 174 illustrates the environment, with one or more probabilities output by the machine learned (ML) model 170. The vehicle 152 can determine one or more outputs with the probability(ies) that one or more elements of the output(s) represent one or more parking locations and/or one or more non-parking locations. The output(s) may be included in the dynamic information.

The probability(ies) can include a probability P3 176, e.g., represented by a star encircling a portion (e.g., a pixel) of the top-down representation (e.g., the top-down representation 162). The probability(ies) can include a probability P4 178, e.g., represented by a star encircling a portion (e.g., a pixel) of the top-down representation 162. The probability P3 176 may be a probability that an element of the output represents a parking location 180. The parking location 180, for example, may include, and/or be represented as, polylines. Alternatively or additionally, the parking location 180, for example, may include, and/or be represented as rasterized image data. The probability P4 178 may be a probability that an element of the output represents a non-parking location 182.

The machine learned (ML) model 124 can output one or more heat maps. For example, a first heat map can include a probability that each individual pixel is a non-drivable area (e.g., the parking location 180). In such an example or another example, a second heat map can include a probability that each individual pixel is a drivable area (e.g., the non-parking location 182).

In some examples, the output(s) from the machine learned (ML) model 170 can be utilized to identify a boundary line 184. The boundary line 184 can include an outline of the parking location 180 determined based on the machine learned (ML) model 170 to control the vehicle 152 as, and/or before, the vehicle 152 enters the parking location 180. In some examples, such as, for an instance in which the vehicle 152 is parking, the vehicle 152 can be controlled to park in the parking location 180. In those or other examples, such as, for an instance in which the vehicle 152 is not parking, the vehicle 152 can be controlled to traverse around the parking location 180, and/or through the non-parking location 182.

At operation 186, the process 100 can include controlling a vehicle based on a trajectory. The trajectory, which can represent one or more trajectories associated with one or more vehicles, such as the vehicle 152, can be determined based on the output of the machine learned (ML) model 170. In some examples, the trajectory(ies) can include a trajectory utilized to control the vehicle 152.

The vehicle 152 approaching the parking location 180 can be controlled to navigate, based on the parking location 180. In some examples, the vehicle 152 approaching the parking location 180 can be controlled to navigate around, in front of, in back or, and/or adjacent to the parking location 180, based on whether the vehicle 152 is parking or not. In those or other examples, the vehicle 152 can be controlled based on objects that maybe objects, such as cones, dividers, temporary curbs, signs, meters, flaggers, etc., or any combination thereof.

In some examples, controlling of the vehicle 152 can be triggered based on parking location information, such as information identifying the parking location 180. In those or other examples, controlling of the vehicle 152 can be triggered based on portions (e.g., temporary curbs, signs, meters, etc.) of the parking location 180.

A confidence value utilized to control the vehicle 152 may be managed (e.g., identified, generated, etc.) based on one or more moving velocities of the dynamic object(s) 154 and/or 156. The confidence value can indicate, based on the dynamic object(s) 154 and/or 156, that the vehicle 152 is following a safe path. The confidence value can indicate, based on the dynamic object 156, that a safe path for moving the vehicle 152 into the parking location 180 to park is a path following the dynamic object 156. The confidence value can indicate, based on the dynamic object 154, that a safe path for moving the vehicle 152 around the parking location 180 is a path following the dynamic object 154.

An example 188 illustrates the environment, with one or more trajectories being determined based on the probability(ies) output by the machine learned (ML) model 170. The vehicle 152 can determine the trajectory(ies), such as a trajectory 190. The vehicle 152 can be controlled based on the trajectory 190, such as for the instance in which the vehicle 152 is not parking. The vehicle 152 can be controlled based on another trajectory, such as for the instance in which the vehicle 152 is parking. The trajectory 190 and/or the other trajectory can be determined based on the parking location 180.

A confidence value utilized to control the vehicle 152 may be managed (e.g., identified, generated, etc.) based on the dynamic object(s) 154 and/or 156. The confidence value can indicate, based on the dynamic object 156, that a safe path for moving the vehicle 152 into the parking location 180 to park is a path following the dynamic object 156. The confidence value can indicate, based on the dynamic object 154, that a safe path for moving the vehicle 152 around the parking location 180 is a path following the dynamic object 154.

In some examples, the vehicle 152, for instance if the vehicle 152 is not parking, can be controlled to follow the dynamic object 154, based on the velocity of the dynamic object 154 being above the threshold velocity and, possibly, based on the velocity of the dynamic object 156 not being above the threshold velocity. In those or other examples, the vehicle 152 can be controlled to follow the dynamic object 154, based on the velocity of the dynamic object 154 being greater than the velocity of the dynamic object 156. In those or other examples, the vehicle 152 can be controlled to follow the dynamic object 154, based on a difference between the velocity of the dynamic object 154 and the velocity of the dynamic object 156 being greater than a threshold difference.

In some examples, the vehicle 152, for instance if the vehicle 152 is parking, can be controlled to follow the dynamic object 156, based on the velocity of the dynamic object 156 not being above the threshold velocity, and, possibly, based on the velocity of the dynamic object 154 being above the threshold velocity. In those or other examples, the vehicle 152 can be controlled to follow the dynamic object 156, based on the velocity of the dynamic object 156 not being greater than the velocity of the dynamic object 154. In those or other examples, the vehicle 152 can be controlled to follow the dynamic object 156, based on a difference between the velocity of the dynamic object 154 and the velocity of the dynamic object 156 being greater than a threshold difference.

FIGS. 2A and 2B are example architectures for implementing dynamic drivable area determinations. The architectures can include one or more top-down representations. With respect to FIG. 2A, an architecture 200 illustrated can include a top-down representation 202 of the representation(s) of an environment (e.g., the environment, as discussed above with reference to FIG. 1A). In some examples, the top-down representation 202 can be utilized to implement the top-down representation 114, as discussed above with reference to FIG. 1A.

The top-down representation 202 can include construction zone related data 204. The construction zone related data 204 can include rasterized input 206 and/or polylines 208. The top-down representation 202 can be generated as the rasterized input 206 and/or the polylines 208. In some example, any of the data in the top-down representation 202 can be represented as the rasterized input 206 and/or the polylines 208. The top-down representation 202, such as the rasterized input 206 and/or the polylines 208, can be generated based on sensor data and map data.

The environment with which the top-down representation 202 is associated can include one or more construction zones identified in the construction zone related data 204. The construction zone(s) can include, for example, the constructions zone 116, as discussed above with reference to FIG. 1A. The construction zone 116 can be included in, and/or conveyed via, the rasterized input 206 and/or the polylines 208. For example, the construction zone 116 may be represented as a rasterized geometric shape (e.g., a portion of a rasterized image) in the rasterized input 206. In such an example or another example, the construction zone 116 may be represented as one or more polylines in the polylines 208.

The construction zone related data 204 may be provided to one or more machine learned (ML) models, such as a machine learned (ML) model 210 and/or a machine learned (ML) model 212. The machine learned (ML) model 210 and/or a machine learned (ML) model 212 may be utilized to implement the machine learned (ML) model 124, as discussed above with reference to FIG. 1A. In some examples, the rasterized input 206 and/or the polylines 208, or any combination thereof, can be provided to the machine learned (ML) model 210 and/or the machine learned (ML) model 212, respectively, or any combination thereof.

In various cases, one or more speeds may be input into the machine learned (ML) model 210 and/or the machine learned (ML) model 212 in various ways. For instance, according to one option, a speed may be directly input into the model (e.g., so that no processing is required for the speed prior to input of the speed to the machine learned (ML) model 210 and/or the machine learned (ML) model 212). A layer of the data input to the machine learned (ML) model 210 and/or the machine learned (ML) model 212 may be input with the speed and/or with one or more vectors of each of the dynamic object(s).

The machine learned (ML) model 210 and/or 212 can generate drivable area and/or non-drivable area related data 214. In some examples, the drivable area and/or non-drivable area related data 214 may include one or more boundary line(s), such as the boundary line 138. The drivable area and/or non-drivable area related data 214 may include a drivable area and/or a non-drivable area (e.g., the drivable area 134 and/or the non-drivable area 136, respectively, as discussed above with reference to FIG. 1A).

The drivable area and/or non-drivable area related data 214 can include probabilities output. The probabilities output may include one or more probabilities. The probabilities output can be provided based on analysis, by the machine learned (ML) model 210 and/or the machine learned (ML) model 212, of the construction zone related data 204 (e.g., the rasterized input 206 and/or the polylines 208).

The probability(ies) can include the probability P1 130 and/or the probability P2 132, as discussed above with reference to FIG. 1A. The probability P1 130 and/or the probability P2 132 can be utilized to control the vehicle (e.g., the vehicle 106).

While the outputs with the probabilities (e.g., the probability P1 130 and/or the probability P2 132) can be determined as discussed above in the current disclosure, it is not limited as such. Any number of outputs with any number of probabilities associated with any number of drivable areas and/or non-drivable areas may be determined in a similar way as for the outputs with the probability P1 130 and/or the probability P2 132.

In various examples, the vehicle 106 can be controlled to veer out of an initially determined drivable area (e.g., the initial drivable area 118) to an area having been initially determined as a non-drivable area (e.g., an area in an oncoming lane). The output(s) can be utilized to re-categorize the non-drivable area as a drivable area (e.g., a tentatively or temporarily drivable area), such as the drivable area 134. The drivable area 134 and/or the non-drivable area 136 identified based on the output(s) may be different from one or more other drivable areas (e.g., the initial drivable area 118) determined otherwise. For example, the drivable area 134 identified by the machine learned (ML) model 210 or 212 may be different from a drivable area (e.g., the initial drivable area 118) indicated by the map data.

In some examples, one or more other vehicles traveling through the environment prior to the vehicle 106 may be utilized to train the machine learned (ML) model(s) 210 and/or 212. The other vehicle(s) may be the same as or similar to the vehicle 106. One or more other paths of the other vehicle(s) may be utilized to train the machine learned (ML) model(s) 210 and/or 212.

In some examples, one or more teleoperators may be utilized to control the other vehicle(s) in some circumstances. The other vehicle(s) may be controlled by the teleoperator(s) as the vehicle(s), for example, travel through the environment prior to the vehicle 106. Output from the teleoperator(s) (e.g., one or more teleoperator devices) may be utilized to train the machine learned (ML) model(s) 210 and/or 212. Edits by the teleoperator(s) to one or more paths of the other vehicle(s) may be utilized to train the machine learned (ML) model(s) 210 and/or 212.

In some examples, one or more emergency vehicles (e.g., one or more police cars, one or more firetrucks, one or more ambulances, etc.) traveling through the environment prior to the vehicle 106 may be ignored, for purposes of training the machine learned (ML) model(s) 210 and/or 212. The emergency vehicle(s) may be ignored for purposes of generating, by the machine learned (ML) model(s) 210 and/or 212, the trajectory(ies) (e.g., the trajectory(ies) 144 and/or 190) associated with the vehicle 106.

In contrast to conventional techniques that may be unable to be utilized to identify certain initial drivable areas and certain initial non-drivable areas, the machine learned (ML) model(s) 210 and/or 212 may be utilized to identify drivable areas (e.g., the drivable area 134) and non-drivable areas (e.g., the non-drivable area 136) according to the techniques discussed herein. Annotated driving data may be utilized to train the machine learned (ML) model(s) 210 and/or 212, which may be utilized to identify the drivable areas (e.g., the drivable area 134) and non-drivable areas (e.g., the non-drivable area 136). In various cases, data collected via input from human drivers in vehicle(s) traversing the construction zone 116 may be utilized as ground truth for generating training data utilized to train the machine learned (ML) model(s) 210 and/or 212.

In some examples, output of the machine learned (ML) model(s) 210 and/or 212 may be utilized to identify data associated with areas adjacent to the drivable area 134 and/or the non-drivable area 136. For instance, output of the machine learned (ML) model(s) 210 and/or 212 may be utilized to identify that one or more areas adjacent to, and/or aside from the drivable area 134, are non-drivable areas.

In various examples, the drivable area 134 can be determined as the vehicle 106 enters the initial drivable area 118. The drivable area 134 can be determined based on an output comprising the probability P1 130 that a first element of a first output represents the drivable area 134 and an output comprising the probability P2 132 that the second element of the second output represents the non-drivable area 136.

The probabilities being compared to a probability threshold may be determined, to identify the drivable area 134 and the non-drivable area 136. The probability P1 130 may be greater than the threshold probability and the probability P2 132 may be less than the threshold probability. The probability P1 130 being greater than the threshold probability and the probability P2 132 being less than the threshold probability may be utilized to generate a trajectory through the drivable area 134.

In some examples, the map data may be utilized to generate dynamic map data. The dynamic map data may include the construction zone 116 through which the vehicle 106 is traversing. The dynamic map data may include temporary data. Existing map data may be identified and utilized for newly identified lanes, temporarily (e.g., and then possibly added to the map data after certain criteria are met, such as identification of the new identified lanes by a number of vehicles that is greater than a threshold number, etc.). For example, the dynamic map data may be different from the map data determined prior to the determination of the dynamic map data, and different from subsequent map data determined after the construction zone 116 is gone and/or removed. The dynamic map data may change based on at least one of i) a level of change associated with the at least road marking and velocity information being greater than a threshold level of change, or ii) a difference between an initial time at which the dynamic map data is generated and a current time being greater than a threshold difference. The dynamic map data changing may include the dynamic map data reverting back to the map data, or the dynamic map data changing to new map data. For example, one or more portions of a road existing after the construction zone 116 is removed may be different from one or more corresponding portions of the road existing prior to the construction zone 116.

In some examples, this information may be used to append to override existing map data. For example, a first vehicle crossing an area may determine a dynamic lane routing schema due to a construction zone or similar and may provide this information to other vehicles for local storage and processing. This may be more beneficial than, for example, appending an existing map and causing all vehicles in a fleet to download the updated map which may be time consuming. In some examples, such temporary data may be tiles or otherwise formatted to align with existing map data. For example, the dynamically determinable drivable surfaces determined using the disclosed techniques may continue through tiles (e.g., defined sections) of a map until they intersect a drivable surface or lane of an existing tile in the map. In this manner, the temporary map data may be integrated into the existing map more readily.

In some examples, an area may be flagged by a vehicle for future update depending on various criteria (the extent to which the dynamically determined lanes deviate from known (e.g., mapped) lanes, the number of construction workers, the amount of time that the construction has existed, etc.). Such information may be shared with other vehicles in the fleet so that other vehicles may know whether to anticipate changed drivable surfaces, perform their own subsequent drivable lane determination, etc. In some examples, a future or periodic mapping of the area can be scheduled depending on the classification of area type (e.g., a permanent construction vs a temporary construction) so that a vehicle can remap the area at a future date to account for the construction changes and the corresponding map tiles be marked appropriately. If the type is determined to be a temporary construction, then the map data may be retained corresponding to the tiles.

In some examples, a speed of a dynamic object 108 may be checked, and/or compared to a threshold speed. If the speed of the dynamic object 108 is greater than a threshold speed for a period of time that is greater than a threshold period of time, the machine learned (ML) model can identify the drivable area 134 at the location of the dynamic object 108. In response to the identifying of the construction zone 116, the vehicle 106 can be controlled to traverse the drivable area 134. The drivable area 134 output by the machine learned (ML) model may be different than the initial drivable area (e.g., the initial drivable area 118) indicated by the map data.

In various examples, output (e.g., output data) generated by one or more vehicles, such as a vehicle (or “previous vehicle”) traversing an initial drivable area (e.g., the initial drivable area 118) prior to the vehicle 106, can be transmitted to a central server (e.g., a server with which the vehicle 106 is in communication). The output can include any information and/or data generated in a similar way as any of the information and/or the data generated by the vehicle 106. The output can be provided to the central server and then downloaded to another vehicle (e.g., the vehicle 106) as it approaches the same environment. The output can be provided to the central server and then downloaded to the vehicle 106 as it approaches the initial drivable area 118. The output can be downloaded to the vehicle 106 to aid the vehicle 106 in traversing the environment. The vehicle 106 can generate a confidence level associated with the output. The confidence level may, in some cases, decrease with respect to a confidence level for the previous vehicle, based on time passing between the previous vehicle encountering the environment (or uploading the outputs) and a current vehicle (e.g., the vehicle 106) consuming the output. Data generated by a previous vehicle may be passed (vie the central server) to another vehicle (e.g., the vehicle 106) to use after the previous vehicle traverses the environment.

Log data of another vehicle under control of a driver and traversing an initial drivable area may be utilized to control the dynamic object 108. Log data of another autonomous vehicle being controlled based on other dynamic map data and the initial drivable area may be utilized to control the dynamic object 108. The log data may be uploaded to a server, and subsequently downloaded by the vehicle 106.

In some examples, one or more permissibilities associated with the environment 200 may change. For examples, a permissibility may indicate whether a lane is a same-direction lane or an oncoming lane. The permissibility(ies) may be determined based on one or more road markings, such as one or more lights, one or more flags (e.g., of one or more human flaggers), one or more signs, etc., or any combination thereof. The permissibility(ies) may indicate that an initial same-direction lane is an on-coming lane.

In some examples, output of the machine learned (ML) model(s) 210 and/or 212 may be utilized to identify data associated with areas adjacent to the drivable area 134 and/or the non-drivable area 136. For instance, output of the machine learned (ML) model(s) 210 and/or 212 may be utilized to identify that areas aside from the drivable area 134 and/or the non-drivable area 136.

With respect to FIG. 2B, an architecture 216 illustrated can include a top-down representation 218 of one or more representations of an environment (e.g., the environment, as discussed above with reference to FIG. 1B). In some examples, the top-down representation 218 can be utilized to implement the top-down representation 162, as discussed above with reference to FIG. 1B.

The top-down representation 218 can include parking destination map area data 220. The parking destination map area data 220 can include rasterized input 222 and/or polylines 224. The top-down representation 218 can be generated as the rasterized input 222 and/or the polylines 224. In some example, any of the data in the top-down representation 218 can be represented as the rasterized input 222 and/or the polylines 224. The top-down representation 218, such as the rasterized input 222 and/or the polylines 224, can be generated based on sensor data and map data. In various examples, the top-down representation 218, the rasterized input 222, and/or the polylines 224, can be generated in a similar way as the top-down representation 202, the rasterized input 206, and/or the polylines 208, as discussed above with reference to FIG. 2A, except for the parking destination map area data 220 instead of the construction zone related data 204, as discussed above with reference to FIG. 2A.

The top-down representation 218 can include one or more the parking destination map areas identified in the parking destination map area data 220. The parking destination map area(s) can include, for example, the parking destination map area 164, as discussed above with reference to FIG. 1B. The parking destination map area 164 can be included in, and/or conveyed via, the rasterized input 222 and/or the polylines 224. For example, the parking destination map area 164 may be represented as a rasterized geometric shape (e.g., a portion of a rasterized image) in the rasterized input 222. In such an example or another example, the parking destination map area 164 may be represented as one or more polylines in the polylines 224.

The parking destination map area(s) may include various types of areas. For example, the parking destination map area(s) (e.g., parking destination map area 164) may be one or more areas around one or more hotels, one or more airports, one or more hotspots (e.g., any place where a probability of parking (e.g., stopping to pick up and/or drop off passengers) is above a threshold or any place where the drivers of the vehicles (e.g., the vehicle 152) have to frequently disengage autonomous driving to park the vehicle 152.

In some examples, candidate parking locations may be identified in various ways. The candidate parking locations may be identified, for example, by applying a threshold to the first output to identify first candidate parking locations in the environment. The candidate parking locations may be identified, for example, by applying a size filter to the first candidate parking locations. The candidate parking locations may be identified, for example, by determining, based on the size filter and the first candidate parking locations, second candidate parking locations in the environment. The size filter, for instance, may be based on the size of the vehicle 152. Locations that are too small may be filtered out, for example,

The parking destination map area data 220 may be provided to one or more machine learned (ML) models, such as a machine learned (ML) model 226 and/or a machine learned (ML) model 228. The machine learned (ML) model 226 and/or the machine learned (ML) model 228 may be utilized to implement the machine learned (ML) model 170, as discussed above with reference to FIG. 1B. In some examples, the rasterized input 222 and/or the polylines 224, or any combination thereof, can be provided to the machine learned (ML) model 226 and/or the machine learned (ML) model 228, respectively, or any combination thereof.

In various cases, one or more speeds may be input into the machine learned (ML) model 226 and/or the machine learned (ML) model 228 in various ways. For instance, according to one option, a speed may be directly input into the model (e.g., so that no processing is required for the speed prior to input of the speed to the machine learned (ML) model 226 and/or the machine learned (ML) model 228). A layer of the data input to the machine learned (ML) model 226 and/or the machine learned (ML) model 228 may be input with the speed and/or with one or more vectors of each of the dynamic object(s).

In various examples, any portion of one or more machine learned (ML) models 226 and/or 228 to which the parking destination map area data 220 is provided may be the same as, or different from, any portion of one or more machine learned (ML) models to which the construction zone related data 204 is provided. For instance, the parking destination map area data 220 is provided to the machine learned (ML) model 226 and/or 228, which may be the same as, or different from, the machine learned (ML) model 210 and/or 212, to which the construction zone related data 204 is provided.

The machine learned (ML) model 226 and/or 228 can generate parking location and/or non-parking location data 230. In some examples, the parking location and/or non-parking location data 230 may include one or more boundary line(s), such as the boundary line 184. The parking location and/or non-parking location data 230 may include a parking location and/or a non-parking location (e.g., the parking location 180 and/or the non-parking location 182, respectively, as discussed above with reference to FIG. 1B).

The parking location and/or non-parking location data 230 can include probabilities output. The probabilities output may include one or more probabilities. The probabilities output can be provided based on analysis, by the machine learned (ML) model 226 and/or 228, of the parking destination map area data 220 (e.g., the rasterized input 222 and/or the polylines 224).

The probability(ies) can include the probability P3 176 and/or the probability P4 178, as discussed above with reference to FIG. 1B. The probability P3 176 and/or the probability P4 178 can be utilized to control the vehicle (e.g., the vehicle 152).

While the outputs with the probabilities (e.g., the probability P3 176 and/or the probability P4 178) can be determined as discussed above in the current disclosure, it is not limited as such. Any number of outputs with any number of probabilities associated with any number of drivable areas and/or non-drivable areas may be determined in a similar way as for the outputs with the probability P3 176 and/or the probability P4 178.

In various examples, the vehicle 152 can be controlled to navigate, instead of based on a parking destination map area data 220 (e.g., the parking destination map area 164), based on the parking location 180 and/or the non-parking location 182. The output(s) can be utilized to re-categorize one or more portions of the parking destination map area 164 as a parking location, such as the parking location 180, and/or a non-parking location, such as the non-parking location 182. The parking location 180 and/or the non-parking location 182 identified based on the output(s) may be different from one or more other areas (e.g., the parking destination map area 164) determined otherwise. For example, the parking location 180 and/or the non-parking location 182 identified by the machine learned (ML) model 226 or 228 may be different from a parking destination map area (e.g., the parking destination map area 164) indicated by the map data.

In some examples, one or more other vehicles traveling through the environment prior to the vehicle 152 may be utilized to train the machine learned (ML) model(s) 226 and/or 228, in a similar, or different, way as for the machine learned (ML) model(s) 210 and/or 212. Output from one or more teleoperator(s) (e.g., one or more teleoperator devices) may be utilized to train the machine learned (ML) model(s) 226 and/or 228, in a similar, or different, way as for the machine learned (ML) model(s) 210 and/or 212.

In some examples, one or more emergency vehicles (e.g., one or more police cars, one or more firetrucks, one or more ambulances, etc.) traveling through the environment prior to the vehicle 106 or 152 may be ignored, for purposes of training the machine learned (ML) model(s) 210 and/or 212. The emergency vehicle(s) may be ignored for purposes of generating, by the machine learned (ML) model(s) 210 and/or 212, the trajectory(ies) (e.g., the trajectory(ies) 144 and/or 190) associated with the vehicle 106 and/or 152.

In contrast to conventional techniques that may be unable to be utilized to identify certain parking destination map areas and certain non-parking destination map areas, the machine learned (ML) model(s) 226 and/or 228 may be utilized to identify parking locations (e.g., the parking location 180) and non-parking locations (e.g., the non-parking location 182) according to the techniques discussed herein. Annotated driving data may be utilized to train the machine learned (ML) model(s) 226 and/or 228, which may be utilized to identify the parking locations (e.g., the parking location 180) and non-parking locations (e.g., the non-parking location 182). In various cases, data collected via input from human drivers in vehicle(s) traversing the parking destination map area 164 may be utilized as ground truth for generating training data utilized to train the machine learned (ML) model(s) 226 and/or 228.

In various examples, the parking destination map area 220 can be determined as the vehicle 152 enters the parking destination map area 220. The parking location 180 can be determined based on an output comprising the probability P3 176 that the first element of the first output represents the parking location 180 and an output comprising the probability P4 178 probability that the second element of the second output represents the non-parking location 182.

The probabilities being compared to a probability threshold may be determined, to identify the parking location 180 and the non-parking location 182. The probability P3 176 may be greater than the threshold probability and the probability P4 178 may be less than the threshold probability. The probability P3 176 being greater than the threshold probability and the probability P4 178 being less than the threshold probability may be utilized to generate a trajectory to park the vehicle 152.

In some examples, the map data may be utilized to generate dynamic map data. The dynamic map data may include a parking destination area through which the vehicle 152 is traversing. The dynamic map data may include temporary data. Existing map data may be identified and utilized for newly identified lanes, temporarily (e.g., and then possibly added to the map data after certain criteria are met, such as identification of the new identified lanes by a number of vehicles that is greater than a threshold number, etc.). For example, the dynamic map data may be different from the map data determined prior to the determination of the dynamic map data, and different from subsequent map data determined after the parking location 180 is removed. The dynamic map data may change based on at least one of i) a level of change associated with the at least road marking and velocity information being greater than a threshold level of change, or ii) a difference between an initial time at which the dynamic map data is generated and a current time being greater than a threshold difference. The dynamic map data changing may include the dynamic map data reverting back to the map data, or the dynamic map data changing to new map data.

In some examples, a speed of a dynamic object 156 may be checked, and/or compared to a threshold speed. If the speed of the dynamic object 156 is less than a threshold speed for a period of time that is less than a first threshold period of time and greater than a second threshold period of time (e.g., as an indication of the dynamic object 156 parking temporarily), the machine learned (ML) model can identify the parking location 180 at the location of the dynamic object 156. In response to the identifying of the parking location 180, the vehicle 156 can be controlled to park in the parking location 180 (e.g., after the dynamic object 156 leaves the parking location 180). The parking location 180 output by the machine learned (ML) model may be different than the initial parking location (e.g., the parking destination map area 164) indicated by the map data.

In some examples, parking destination map areas may be areas around hotels, airports, hotspots (e.g., any place where a probability of pickup/drop off is above a threshold and/or any place where drivers have to frequently disengage the autonomous driving to park the vehicle).

In various cases, characteristics of dynamic objects may be utilized to identify the parking location. For example, the characteristics may include velocity, speed, a door state (e.g., as indicated by a door of the dynamic object 156 being open), one or more status of lights of the dynamic object 156, one or more other parking signals of various types indicating whether the dynamic object 156 is going to part or not, or any combination thereof. Various characteristics (e.g., as identified via the sensor data of the vehicle 152), for instance, such as a slow speed or stopped position; brake lights being activated, parking lights being activated; headlights, taillights, and/or brake lights being deactivated (e.g., after activation of the brake lights), one or more passenger/driver doors and/or a trunk door being open, etc., or any combination thereof, may be identified as being indicative of the dynamic object 156 (e.g., and/or any other/previous vehicle) parking. The characteristics may be utilized (e.g., by the vehicle 152) to determine the parking location 180 exists and the location, shape, and/or longevity (e.g., time until no longer existing) of the parking location 180. The parking location 180, which may be temporary, may exist for a period of time and then cease to exist.

In various examples, dynamic map data may be generated based on one or more probabilities (e.g., the first probability and the second probability). The dynamic map data may include one or more parking spots, such as a first parking spot (e.g., a spot in the parking location 180) and a second parking spot (e.g., another parking spot). The first parking spot, for instance, may be used to determine the parking location 180 based on the first parking spot being associated with a lower quality level and a higher availability level than the second parking spot. An area associated with the first parking spot may be identified as the parking location 180.

In some examples, the quality level may include one or more of various characteristics. The characteristic(s) may include the first parking spot being easier to access, larger, easier for passengers to enter and leave, easier to see (e.g., more visible from pedestrian areas and/or adjacent areas to the road, more visible from the road, etc.), flatter, smoother (e.g., smoother pavement, less bumps, etc.), etc., or any combination thereof. Any parking spot being less available may include the parking spot being partially and/or fully occupied (e.g., by vehicles and/or pedestrians), an occupation of the parking stop being for a longer period of time, etc., or any combination thereof. By controlling the vehicle 152 to park in the first parking spot, the vehicle 152 may be able to park to reduce congestion and/or improve safely, even if the first parking spot is less ideal/safer/convenient, etc., than the second parking spot. However, the vehicle 152 may park in the second parking spot in such as instances as an availability level of the first parking spot being within a threshold availability level difference from an availability level of the second parking spot, and/or being similarly available as the second parking spot.

In various examples, output (e.g., output data) generated by one or more vehicles, such as a vehicle (or “previous vehicle”) traversing a parking destination map area (e.g., the parking destination map area 164) prior to the vehicle 152, can be transmitted to a central server (e.g., a server with which the vehicle 152 is in communication). The output can include any information and/or data generated in a similar way as any of the information and/or the data generated by the vehicle 152. The output can be provided to the central server and then downloaded to another vehicle (e.g., the vehicle 152) as it approaches the same environment. The output can be provided to the central server and then downloaded to the vehicle 152 as it approaches the parking destination map area 164. The output can be downloaded to the vehicle 152 to aid the vehicle 152 in traversing the environment. The vehicle 152 can generate a confidence level associated with the output. The confidence level may, in some cases, decrease with respect to a confidence level for the previous vehicle, based on time passing between the previous vehicle encountering the environment (or uploading the outputs) and a current vehicle (e.g., the vehicle 152) consuming the output. Data generated by a previous vehicle may be passed (vie the central server) to another vehicle (e.g., the vehicle 152) to use after the previous vehicle traverses the environment.

Log data of another vehicle under control of a driver and traversing a parking destination map area may be utilized to control the dynamic object 156. Log data of another autonomous vehicle being controlled based on other dynamic map data and traversing the parking destination map area may be utilized to control the dynamic object 156. The log data may be uploaded to a server, and subsequently downloaded by the vehicle 152.

In some examples, one or more permissibilities associated with the environment 216 may change. For examples, a permissibility may indicate whether a lane is a same-direction lane or an oncoming lane. The permissibility(ies) may be determined based on one or more road markings, such as one or more lights, one or more flags (e.g., of one or more human flaggers), one or more signs, etc., or any combination thereof. The permissibility(ies) may indicate that an initial same-direction lane is an on-coming lane.

In some examples, output of the machine learned (ML) model(s) 226 and/or 228 may be utilized to identify data associated with areas adjacent to the parking location 180 and/or the non-parking location 180. For instance, output of the machine learned (ML) model(s) 226 and/or 228 may be utilized to identify that areas aside from the parking location 180 are non-parking locations.

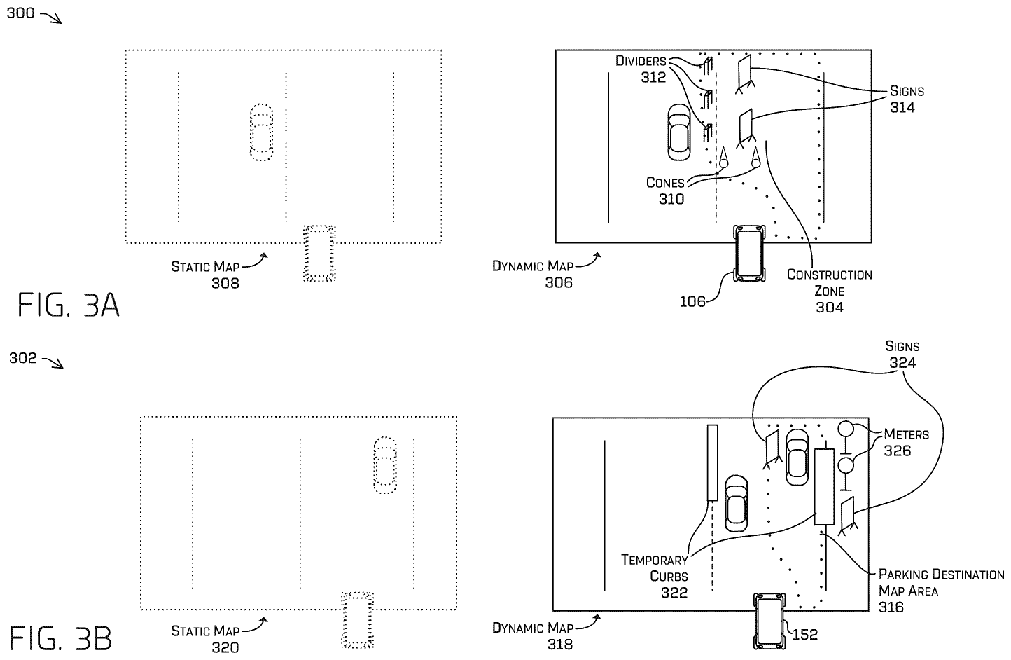

FIGS. 3A and 3B depict example environments 300 and 302 including construction zones and parking destination map areas. With respect to FIG. 3A, and in at least one example, the environment 300 may include a construction zone 304. The environment 300 may be portrayed by a dynamic map 306 being utilized, for dynamic drivable area determining management. The dynamic map 306 may be utilized, alternatively or additionally to a static map 308, for dynamic drivable area determining management. In some examples, the dynamic map 306 can be generated based on the top-down representation 114.

The dynamic map 306 may be output by a machine learning (ML) model (e.g., machine learned (ML) model 124, as discussed above with reference to FIG. 1A) and may portray one or more of the same areas of the environment 300 as the static map 308. One or more outputs from the machine learning (ML) model 124 may indicate where drivable regions (e.g., the drivable area 134, as discussed above with reference to FIG. 1A) and/or non-drivable regions (e.g., the non-drivable area 136, as discussed above with reference to FIG. 1A) are located. The dynamic map 306 may be more accurate than maps utilized by existing systems, the maps utilized by existing systems being static maps such as the static map 308. The dynamic map 306 may be more up-to-date than the static map 308. One or more portions (e.g., the drivable area 134 and/or the non-drivable area 136) of the environment 300 may be represented in the dynamic map 306 but not the static map 308, as a result of the dynamic map 306 being more up-to-date than the static map 308. The dynamic map 306 may include the vehicle 106, and/or the dynamic object 108.

For example, the portion(s) of the environment 300 may include one or more cones 310, one or more dividers 312, one or more signs 314, one or more objects of any type, or any combination thereof. The portion(s) of the environment 300, such as the cone(s) 310, the divider(s) 312, the sign(s) 314, etc., not being represented in the static map 308, may be a result of data that is outdated having been utilized to generate the static map 308. The outdated data may include data being utilized to generate the static map 308 prior to placement of the portion(s) of the environment 300, such as the cone(s) 310, the divider(s) 312, the sign(s) 314, etc. On or more traffic control indications, such as the sign(s) 314, may include a lanes merge ahead sign, an entering construction zone sign, a do not enter sign, a construction zone ahead sign, a flagger sign, etc., or any combination thereof.

The dynamic map 306 can be managed (e.g., identified, determined, generated, modified updated, deleted, utilized, etc., or any combination thereof) to determine a dynamic drivable area. For example, the dynamic drivable area can include one or more areas with which one or more elements are determined to be associated. The element(s) associated with the area(s) in the dynamic drivable area may represent one or more probabilities that the element(s) represent one or more portions of the dynamic drivable area. The element(s) may include the element identified by the probability P1 130, as discussed above with reference to FIG. 1.

The dynamic map 306 can be generated based on the portion(s) of the environment, the top-down representation 114, and the probability(ies). Generating the dynamic map 306 can include identifying the portion(s) of the environment 300 based on sensor data and map data, inputting the top-down representation 114 into a machine learned model, and generating the probability(ies) (e.g., the probability P1 130, the probability P2 132, etc., or any combination thereof). The portion(s) of the environment, the top-down representation 114, and the probability(ies) can be utilized to generate the dynamic map 306. The dynamic map 306 can be generated dynamically, such as on an ongoing basis as the vehicle 106 traverses the environment.

With respect to FIG. 3B, and in at least one example, the environment 302 may include a parking destination map area 316. The environment 300 may be portrayed by a dynamic map 318 being utilized, for dynamic drivable area determining management. The dynamic map 318 may be utilized, alternatively or additionally to a static map 320, for dynamic drivable area determining management. In some examples, the dynamic map 318 can be generated based on the top-down representation 162.

The dynamic map 318 may be output by a machine learning (ML) model (e.g., machine learned (ML) model 170, as discussed above with reference to FIG. 1B) and may portray one or more of the same areas of the environment 300 as the static map 320. One or more outputs from the machine learning (ML) model 170 may indicate where parking locations (e.g., the parking location 180, as discussed above with reference to FIG. 1B) and/or non-parking locations (e.g., the non-parking location 182, as discussed above with reference to FIG. 1B) are located. The dynamic map 318 may be more accurate than maps utilized by existing systems, the maps utilized by existing systems being static maps such as the static map 320. The dynamic map 318 may be more up-to-date than the static map 320. One or more portions (e.g., the parking location 180 and/or the non-parking location 182) of the environment 300 may be represented in the dynamic map 318 but not the static map 320, as a result of the dynamic map 318 being more up-to-date than the static map 320. The dynamic map 318 may include the vehicle 152, the dynamic object 154, and/or the dynamic object 156.

For example, the portion(s) of the environment 300 may include one or more temporary curbs 322, one or more signs 324, one or more parking meters (or “meter(s)”) 326, one or more objects of any type, or any combination thereof. In some instances, traffic control indications, such as the sign(s) 324, may include a parking sign, an entering parking area sign, a flagger sign, etc. The portion(s) of the environment 300, such as the temporary curb(s) 322, the sign(s) 324, the meter(s) 326, etc., not being represented in the static map 320, may be a result of data that is outdated having been utilized to generate the static map 320. The outdated data may include data being utilized to generate the static map 320 prior to placement of the portion(s) of the environment 300, such as the temporary curb(s) 322, the sign(s) 324, the meter(s) 326, etc.

The dynamic map 318 can be managed (e.g., identified, determined, generated, modified updated, deleted, etc., or any combination thereof) and utilized to determine a dynamic drivable area. For example, the dynamic drivable area can include one or more areas with which one or more elements are determined to be associated. The element(s) associated with the area(s) in the dynamic drivable area may represent one or more probabilities that the element(s) represent one or more portions of the dynamic drivable area. The element(s) may include the element identified by the probability P3 176, as discussed above with reference to FIG. 1.

The dynamic map 318 can be generated based on the portion(s) of the environment, the top-down representation 162, and the probability(ies). Generating the dynamic map 318 can include identifying the portion(s) of the environment 302 based on sensor data and map data, inputting the top-down representation 162 into a machine learned model, and generating the probability(ies) (e.g., the probability P3 176, the probability P4 178, etc., or any combination thereof). The portion(s) of the environment, the top-down representation 162, and the probability(ies) can be utilized to generate the dynamic map 318. The dynamic map 318 can be generated dynamically, such as on an ongoing basis as the vehicle 152 traverses the environment.

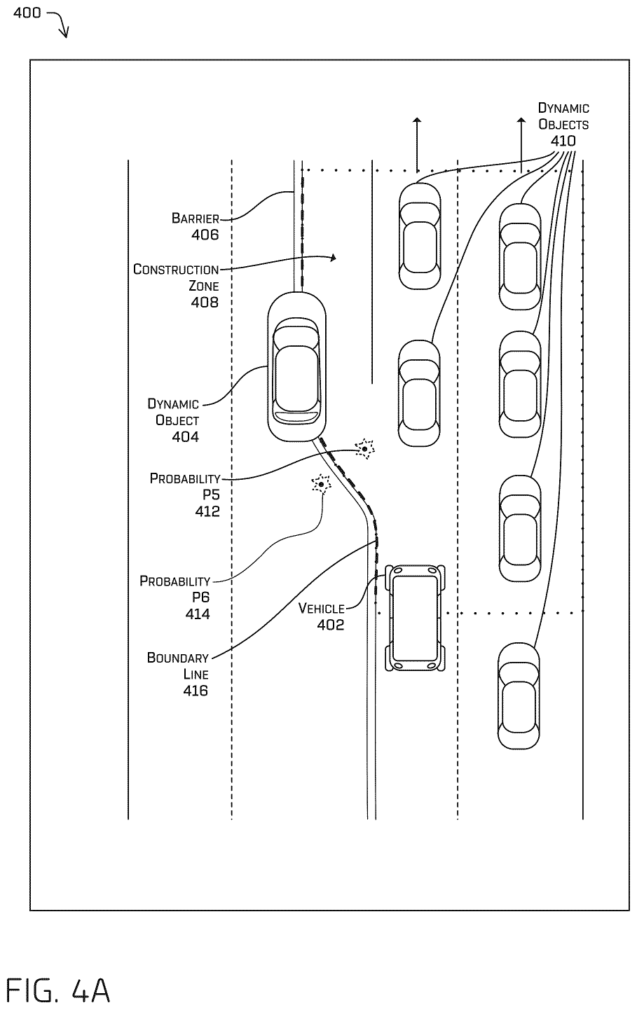

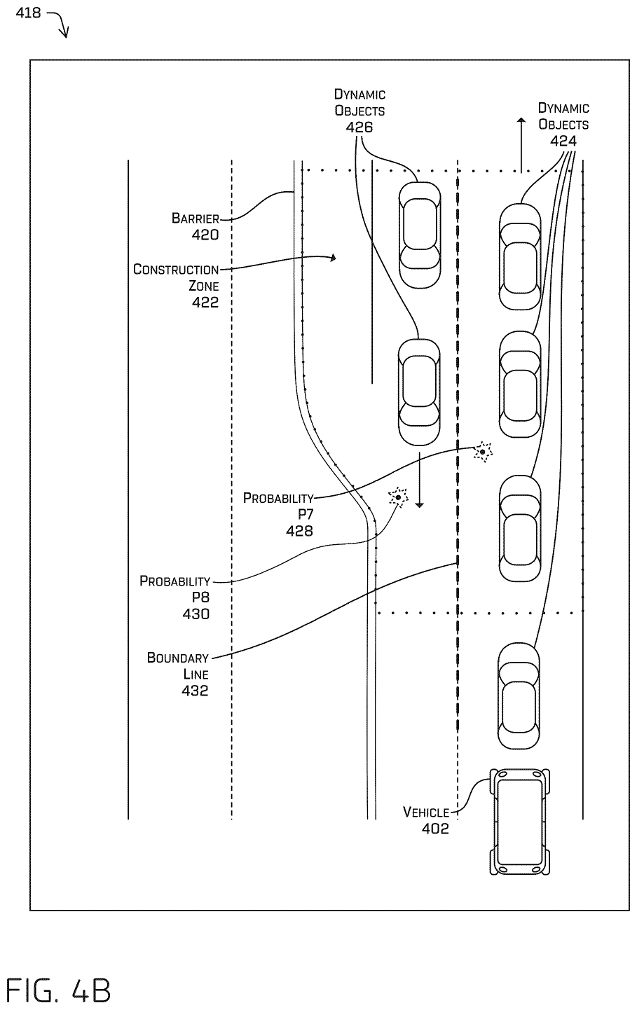

FIGS. 4A and 4B depict example environments 400 including a construction zone and a dynamic object not to be followed by a vehicle based on observed attributes. With respect to FIG. 4A, the environments may include an environment 400, which may include the vehicle, such as a vehicle 402, traversing through the environment 400. The vehicle 402 may be the same type as, and/or may be implemented in a similar way as, the vehicle 106 or 152, as discussed above with reference to FIG. 1.

The vehicle 402 can identify sensor data, and one or more dynamic objects based on the sensor data. The sensor data and/or the dynamic object(s) can be utilized to generate dynamic drivable area determining information (or “dynamic information”). The dynamic information may be utilized to control the vehicle 402. The dynamic information can include a top-down representation being generated based on the sensor data and/or the dynamic object(s). For example, the top-down representation can be generated in a similar way as the top-down representation 114 or 162. The top-down representation can include the vehicle 402, and/or any other portions, any of the objects, etc., or any combination thereof, of the environment 400. The top-down representation can be dynamically updated as the vehicle 402 travels through the environment.

The dynamic information may indicate that the environment 400 includes a dynamic object 404, and one or more dynamic objects 410. The dynamic information may indicate that the environment 400 includes a barrier 406 and a construction zone 408. The barrier 406 may be in, next to, surrounding, abutting, adjacent to, temporarily constructed for, permanently placed, separate from, etc., or any combination thereof, the construction zone 408.

The vehicle 402 may be controlled based on the dynamic object(s) 410 instead of the dynamic object 404. The dynamic information may be utilized by the vehicle 402 to determine that following the dynamic object 404 creates a safety risk, and/or result in a violation of one or more traffic laws and/or one or more regulations. The dynamic information may be utilized by the vehicle 402 to determine that a level of safety associated with movement of the vehicle 402 would be increased by following the dynamic object 404 instead of the dynamic object(s) 410.

The dynamic information may indicate that the dynamic object 404 is a different type from the vehicle 402. The dynamic information may indicate that the dynamic object 404 is, possibly, be a different type from at least one of the dynamic object(s) 410. In some examples, the dynamic information may indicate that the dynamic object 404 is any of a sport utility vehicle (SUV), a truck, a van, and so on. In those or other examples, the vehicle 402 may determine vehicle information indicating that the vehicle 402 is any of a sedan, a compact vehicle, a compact sport utility vehicle (SUV), any other type of non-SUV, and so on. In those or other examples, the dynamic information may indicate, possibly, at least one of the dynamic object(s) 410, may be any of a sedan, a compact vehicle, a compact sport utility vehicle (SUV), any other type of non-SUV, and so on.

In some examples, the dynamic information may indicate that the dynamic object 404 has one or more different characteristics from, the vehicle 402, and possibly, at least one of the dynamic object(s) 410. In those or other examples, the dynamic information may indicate that the dynamic object 404 is larger than the vehicle 402, and possibly, at least one of the dynamic object(s) 410. In those or other examples, the dynamic information may indicate that the dynamic object 404 has relatively larger wheels, relatively thicker tires, a relatively more powerful engine, a relatively more robust suspension system, a relatively larger amount of clearance between the ground (e.g., a surface of the road or trail beneath the dynamic object 404) and an undercarriage, a relatively more robust drive train, etc., or any combination thereof, than the vehicle 402, and possibly, at least one of the dynamic object(s) 410.

In various examples, the dynamic information may include a size, a height, a weight, a wheel size, a tire size, an engine size, a suspension system type, a clearance height, a drive train type, etc. The dynamic information may be determined based on the sensor data and/or one or more types of data obtained remotely (e.g., via one or more networks, such as one or more wireless networks). The data obtained remotely may be based on the sensor data, one or more signals transmitted with, and/or based on, the sensor data, and/or one or more signals received based on the transmitted signals.

One or more outputs may be determined based on the dynamic information. The output(s) may include one or more probabilities that one or more elements of the output(s) represent one or more drivable areas and/or one or more non-drivable areas. The output(s) may be included in the dynamic information. The output(s) may include an output with a probability P5 412, of the probability(ies), that an element of the output represents a drivable area. The output(s) may include an output with a probability P6 414, of the probability(ies), that an element of the output represents a non-drivable area.

The dynamic information may be utilized by the vehicle 402 to determine that a likelihood that the dynamic object 404, but not the vehicle 402, is capable of crossing the barrier 406 is greater than a threshold likelihood. The dynamic object 404 may be capable of travelling over the barrier 406. The dynamic object 404 may have capabilities enabling the dynamic object 404 to perform maneuvers. The vehicle 402, and, possibly, at least one of the dynamic object(s) 410, may be incapable of performing the maneuvers of the dynamic object 404. The dynamic information may be utilized by the vehicle 402 to determine that a likelihood that the barrier 406 is too high and/or large for the vehicle 402 to pass over and/or through is greater than a threshold likelihood. The dynamic information may be utilized by the vehicle 402 to determine a likelihood that the vehicle 402 is unable to safely travel through and/or over the barrier 406 is greater than a threshold likelihood.

The dynamic information may indicate that the dynamic object 404 travels differently from the dynamic object(s) 410. The dynamic information may indicate that the dynamic object 404 travels toward, and/or passes by, through, and/or over, the barrier 406. The dynamic information may indicate that the dynamic object 404 partially and/or completely travels through and/or exit the construction zone 408 at a different location than for at least one of the dynamic object(s) 410. For example, the dynamic information may indicate that the dynamic object 404 partially and/or completely travels through and/or exit the construction zone 408 at a different location than for all of the dynamic object(s) 410. The dynamic information may indicate that the dynamic object 404 enters and/or travels through a non-drivable area.

The dynamic information may indicate that at least one of the dynamic object(s) 410 avoids travelling over the barrier 406. The dynamic information may indicate that all of the dynamic object(s) 410, in some cases, avoid travelling over the barrier 406. The dynamic information may indicate that the dynamic object(s) 410 travels next to, and/or relatively parallel to, the barrier 406, in contrast to the dynamic object 404. The dynamic information may indicate that the dynamic object(s) 410 travel in the construction zone 408. The dynamic information may indicate that the dynamic object(s) 410 partially and/or completely exit the construction zone 408 at the location other than the different location at which the dynamic object 404 exits. The dynamic information may indicate that the dynamic object(s) 410 stay in at least one lane of the road, in contrast to the dynamic object 404, which may travel over the barrier 406. The dynamic information may indicate that the dynamic object(s) 410 stay in and/or travel through the construction zone 408 and/or a drivable area.

The dynamic information may indicate that the behavior(s) of the dynamic object(s) 410 are relatively similar to one another, in contrast to the behavior of the dynamic object 404. The dynamic information may indicate that the dynamic object(s) 410 are moving at relatively a similar speed as one another, and in relatively a same direction as one another, in contrast to a speed and a direction of the dynamic objection 404. The dynamic information may indicate that the dynamic object(s) 410 are relatively predictable, and/or may undergo relatively small changes of speed and/or direction. The dynamic information may indicate that the changes of speed and/or direction of the dynamic object(s) 410 are more predictable, and/or less drastic and/or extreme, than changes of speed and/or direction of the dynamic object 404.

The dynamic information may indicate that at least one of the dynamic object(s) 410 is moving at a speed that is less than a speed of the dynamic object 404. For example, the dynamic object(s) 410 may be stopped. The dynamic information may indicate that an average speed of at least one of the dynamic object(s) 410 is less than a speed of the dynamic object 404. The dynamic information may indicate that a speed of a fastest of any of the dynamic object(s) 410 is less than the speed of the dynamic object 404. The dynamic information may indicate that at least one of the dynamic object(s) 410 is moving at a speed that is within a threshold difference from a speed of at least another one of the dynamic object(s) 410.

The dynamic information may include differences between speeds of dynamic objects. The dynamic information may indicate that a difference between a speed of at least one of the dynamic object(s) 410 and at least another one of the dynamic object(s) 410 is less than a difference between a speed of at least one of the dynamic object(s) 410 and a speed of the dynamic object 404. The dynamic information may indicate that a difference between a speed of a fastest one the dynamic object(s) 410 and a speed of the dynamic object 404 is greater than a threshold difference. The dynamic information may indicate that a difference between an average speed of at least one of the dynamic object(s) 410 and a speed of the dynamic object 404 is greater than a threshold difference.

The speeds and/or differences between speeds can be utilized to identify a confidence value associated with an area through which the dynamic object 404 is travelling. The speeds and/or differences between speeds, the characteristics of the dynamic object 404, and/or the barrier 406, may be utilized to identify the confidence value associated with the area through which the dynamic object 404 is travelling. The dynamic object(s) 410 being more likely to travel at relatively lower speeds due to traffic congestion, than the dynamic object 404, may be utilized to identify the confidence value associated with the area through which the dynamic object 404 is travelling. The dynamic object(s) 410 being more likely to travel at relatively similar speeds with respect to one another, in contrast to the dynamic object 404 travelling over the barrier 406, may be utilized to identify the individual confidence value associated with the area through which the dynamic object 404 is travelling.

The speeds and/or differences between speeds can be utilized to identify one or more individual confidence values associated with one or more corresponding areas through which corresponding dynamic object(s) 410 are travelling. The speeds and/or differences between speeds may be utilized as indications that the area(s) through which the dynamic object(s) 410 are travelling are the drivable area(s), based on the individual confidence value(s) associated with corresponding dynamic object(s) 410. The dynamic object(s) 410 travelling at relatively lower speeds due to congestion in the area(s) without the barrier 406 may be utilized to identify the individual confidence value(s) associated with the area(s) through which the dynamic object(s) 410 are travelling. The dynamic object(s) 410 being more likely to travel at relatively similar speeds with respect to one another, in contrast to the dynamic object 404 travelling over the barrier 406, may be utilized to identify the individual confidence value(s) associated with the area(s) through which the dynamic object(s) 410 are travelling. The confidence value(s) associated with the area(s) through which the dynamic object(s) 410 may be larger than the confidence value associated with the area through which the dynamic object 404 is travelling.

While the vehicle 402 can make determinations associated with the area through which the dynamic object 404 is travelling, as discussed above in the current disclosure, it is not limited as such. In some examples, the vehicle 402 can make, based on dynamic information, determinations associated with any types of objects in a construction one and/or parking destination map area in a similar way as for the area through which the dynamic object 404 is travelling. In those or other examples, the vehicle 402 can make, based on dynamic information, determinations associated with any areas through which any types of dynamic objects (e.g., vans, tractors, any other types of vehicles and/or moving objects, etc.) are travelling in a similar way as for the area through which the dynamic object 404 is travelling.

In some examples, the output(s) from a machine learned (ML) model (e.g., the machine learned (ML) model 124 and/or 170, as discussed above with reference to FIGS. 1A and 1B) can be utilized to identify a boundary line 416. The boundary line 416, which may be utilized to determine the boundary line 138, as discussed above with reference to FIG. 1A) can be utilized as an outline of the drivable area. One or more of any number of boundary lines associated with the drivable area may be managed (e.g., identified, determined, generated, modified updated, deleted, utilized, etc., or any combination thereof) in a similar way as for the boundary line 416, for any type of temporary and/or tentative area (e.g., the construction zone 408).

While the vehicle 402 may be controlled through the construction zone 408 as discussed above in the current disclosure, it is not limited as such. In various examples, the vehicle 402 may be controlled through a parking destination map area and/or any other temporary and/or tentative area in a similar way as for the construction zone 408.

With respect to FIG. 4B, the environments may include an environment 418, which may include the vehicle, such as a vehicle 402, traversing through the environment 418. The vehicle 402 may be the same type as, and/or may be implemented in a similar way as, the vehicle 106 or 152, as discussed above with reference to FIG. 1.

The vehicle 402 can identify sensor data, and one or more dynamic objects based on the sensor data. The sensor data and/or the dynamic object(s) can be utilized to generate dynamic drivable area determining information (or “dynamic information”) and a top-down representation, in a similar way as the dynamic information and the top-down representation, respectively, generated in FIG. 4A.

The dynamic information may indicate that the environment 418 includes one or more dynamic objects (e.g., one or more same direction dynamic objects) 424, and one or more dynamic objects (e.g., one or more oncoming dynamic object(s)) 426. The dynamic information may indicate that the environment 418 includes a barrier 420 and a construction zone 422. The barrier 420 may be in, next to, surrounding, abutting, adjacent to, temporarily constructed for, permanently placed, separate from, etc., or any combination thereof, the construction zone 422.

The vehicle 402 may be controlled based on the dynamic object(s) 424 instead of the dynamic object(s) 426. The dynamic information may be utilized by the vehicle 402 to determine that following the dynamic object(s) 426 creates a safety risk, and/or result in a violation of one or more traffic laws and/or one or more regulations. The dynamic information may be utilized by the vehicle 402 to determine that a level of safety associated with movement of the vehicle 402 would be increased by following the dynamic object(s) 424 instead of the dynamic object(s) 426. The dynamic information may be utilized by the vehicle 402 to determine that a level of safety associated with movement of the vehicle 402 would be increased, based on the dynamic object(s) 424 moving in a same direction as the vehicle 402 and the dynamic object(s) 426 moving in an oncoming direction of the vehicle 402.

One or more outputs may be determined based on the dynamic information. The output(s) may include one or more probabilities that one or more elements of the output(s) represent one or more drivable areas and/or one or more non-drivable areas. The output(s) may be included in the dynamic information. The output(s) may include an output with a probability P7 428, of the probability(ies), that an element of the output represents a drivable area. The output(s) may include an output with a probability P8 430, of the probability(ies), that an element of the output represents a non-drivable area.

In some examples, the output(s) from a machine learned (ML) model (e.g., the machine learned (ML) model 124 and/or 170, as discussed above with reference to FIGS. 1A and 1B) can be utilized to identify a boundary line 432. The boundary line 432, which may be determined in a similar way as the boundary line 138, as discussed above with reference to FIG. 1A) can be utilized as an outline of the drivable area. One or more of any number of boundary lines associated with the drivable area may be managed (e.g., identified, determined, generated, modified updated, deleted, utilized, etc., or any combination thereof) in a similar way as for the boundary line 432, for any type of temporary and/or tentative area (e.g., the construction zone 422).

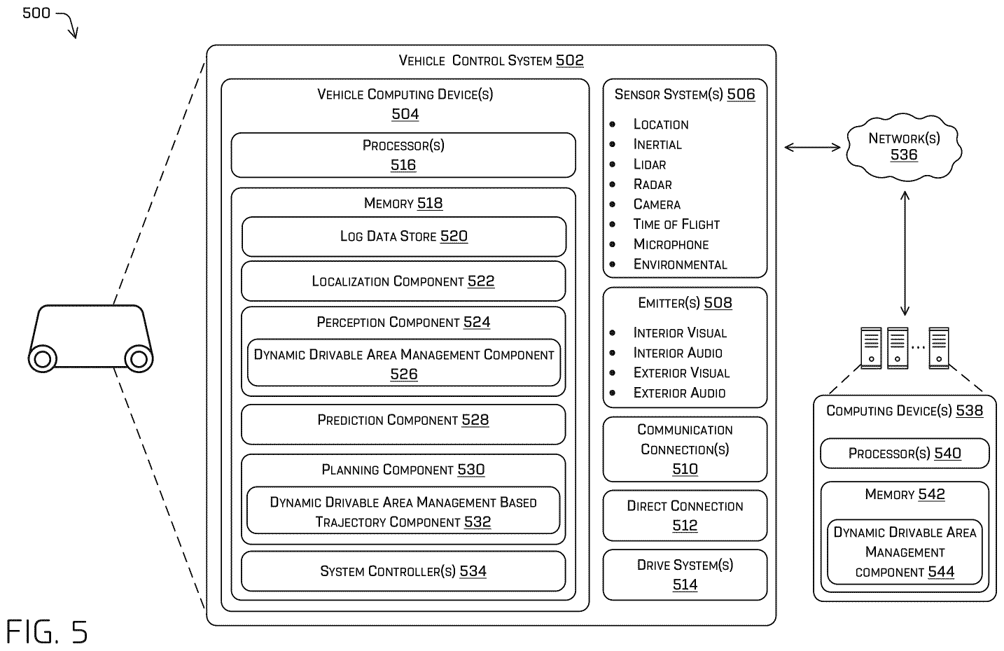

FIG. 5 illustrates an example computing environment 500 that may be used to implement the driving dynamic drivable area determining management systems, in accordance with one or more examples of the disclosure. The computing environment 500 may include a vehicle control system 502 and one or more computing devices (e.g., the computing device(s) 538, as discussed below in further detail). The vehicle control system 502 may include various software-based and/or hardware-based components of an autonomous vehicle, and may be used to control autonomous vehicles traversing through physical environments and/or simulated vehicles operating within virtual and/or log-based simulations. The vehicle control system 502 may be included in a vehicle utilized to implement at least one of the vehicles 106, 152, and 402, as discussed above with reference to FIGS. 1-4.

In this example, the vehicle control system 502 and one or more other devices (e.g., the computing device(s) 538, as discussed below in further detail) are illustrated as discrete computing systems communicating over one or more networks (e.g., one or more networks 536, as discussed below in further detail), although in other implementations the functionality of each of the systems 502, the computing device(s) 538, may be carried out in the same computing environment. By way of non-limiting example, software executing the functionality of the vehicle control system 502 may be uploaded or otherwise incorporated into the computing device(s) 538 and/or software executing the computing device(s) 538 may be uploaded to or otherwise made incorporated into the vehicle control system 502.

The vehicle control system 502 can be a hardware-based and/or software-based controller for a driverless vehicle, such as an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In some instances, the vehicle control system 502 may operate within a real associated vehicle, such as a fully or partially autonomous vehicle having any other level or classification. In some instances, the techniques described herein may be usable by non-autonomous vehicles as well. Additionally or alternatively, the vehicle control system 502 may operate independently from any vehicle, for example, as a hardware and software-based controller for a simulated vehicle executing in a computing environment during the development, testing, and validation processes for the vehicle control system 502. In addition, while implementations of the vehicle control system 502 described herein may include simulating a control system of an autonomous vehicle, semi-autonomous vehicle, or a non-autonomous vehicle, some of the techniques may be in a simulated environment, using a simulated vehicle.

The vehicle control system 502 can be used for any configuration of real or simulated vehicles, such as, for example, a van, a sport utility vehicle, a cross-over vehicle, a truck, a bus, an agricultural vehicle, and/or a construction vehicle. For instance, the associated vehicle for the vehicle control system 502 can be powered by one or more internal combustion engines, one or more electric motors, hydrogen power, any combination thereof, and/or any other suitable power sources. Although the associated vehicle may have four wheels, the vehicle control system 502 and associated techniques described herein can be incorporated into vehicles having fewer or a greater number of wheels, and/or tires. The vehicle control system 502 can control vehicles having four-wheel steering and can operate generally with equal or similar performance characteristics in all directions, for example, such that a first end of the vehicle is the front end of the vehicle when traveling in a first direction, and such that the first end becomes the rear end of the vehicle when traveling in the opposite direction. Similarly, a second end of the vehicle is the front end of the vehicle when traveling in the second direction, and such that the second end becomes the rear end of the vehicle when traveling in the opposite direction. These example characteristics may facilitate greater maneuverability, for example, in small spaces or crowded environments, such as parking lots and/or urban areas.

The vehicle control system 502 can include one or more computing devices 504, one or more sensor systems 506, one or more emitters 508, one or more communication connections 510 (also referred to as communication devices and/or modems), at least one direct connection 512 (e.g., for physically coupling with the vehicle to exchange data and/or to provide power), and one or more drive systems 514. The sensor system(s) 506 can be configured to capture sensor data associated with an environment.

The sensor system(s) 506 can include time-of-flight sensors, location sensors (e.g., GPS, compass, etc.), inertial sensors (e.g., inertial measurement units (IMUs), accelerometers, magnetometers, gyroscopes, etc.), lidar sensors, radar sensors, sonar sensors, infrared sensors, cameras (e.g., RGB, IR, intensity, depth, etc.), microphone sensors, environmental sensors (e.g., temperature sensors, humidity sensors, light sensors, pressure sensors, etc.), ultrasonic transducers, wheel encoders, etc. The sensor system(s) 506 can include multiple instances of each of these or other types of sensors. For instance, the time-of-flight sensors can include individual time-of-flight sensors located at the corners, front, back, sides, and/or top of the real or simulated vehicle associated with the vehicle control system 502. As another example, the camera sensors can include multiple cameras disposed at various locations about the exterior and/or interior of the associated real or simulated vehicle. The sensor system(s) 506 can provide input to the computing device(s) 504.

The vehicle control system 502 can also include the emitter(s) 508 for controlling the emitting of light and/or sound via the real or simulated vehicle associated with the vehicle control system 502. The emitter(s) 508 in this example include interior audio and visual emitters to communicate with passengers of the vehicle. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 508 in this example also include exterior emitters. By way of example and not limitation, the exterior emitters in this example include lights to signal a direction of travel or other indicators of vehicle action (e.g., indicator lights, signs, light arrays, etc.), and one or more audio emitters (e.g., speakers, speaker arrays, horns, etc.) to audibly communicate with pedestrians or other nearby vehicles, one or more of which may comprise acoustic beam steering technology.

The vehicle control system 502 can also include the communication connection(s) 510 that enable communication between the vehicle control system 502 and one or more other local or remote computing devices (e.g., a remote teleoperations computing device) or remote services. For instance, the communication connection(s) 510 can facilitate communication with other local computing device(s) on the associated real or simulated vehicle, and/or the drive system(s) 514. Also, the communication connection(s) 510 can allow the vehicle to communicate with other nearby computing device(s) (e.g., other nearby vehicles, traffic signals, etc.).

The communications connection(s) 510 can include physical and/or logical interfaces for connecting the computing device(s) 504 to another computing device or one or more external networks (e.g., the Internet). For example, the communications connection(s) 510 can enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short range communications (DSRC), or any suitable wired or wireless communications protocol that enables the respective computing device to interface with the other computing device(s). In at least some examples, the communication connection(s) 510 may comprise the one or more modems as described in detail above.

In at least one example, the vehicle control system 502 can include one or more drive systems 514. In some examples, the real or simulated vehicle associated with the vehicle control system 502 can have a single drive system 514. In at least one example, if the vehicle has multiple drive systems 514, individual drive systems 514 can be positioned on opposite ends of the associated vehicle (e.g., the front and the rear, etc.). In at least one example, the drive system(s) 514 can include one or more sensor systems (e.g., any of the sensor system(s) 506) to detect conditions of the drive system(s) 514 and/or the surroundings of the vehicle. By way of example and not limitation, the sensor system(s) on the drive system(s) 514 can include one or more wheel encoders (e.g., rotary encoders) to sense rotation of the wheels of the drive systems, inertial sensors (e.g., inertial measurement units, accelerometers, gyroscopes, magnetometers, etc.) to measure orientation and acceleration of the drive system, cameras or other image sensors, ultrasonic sensors to acoustically detect objects in the surroundings of the drive system, lidar sensors, radar sensors, etc. Some sensors, such as the wheel encoders can be unique to the drive system(s) 514. In some cases, the sensor system(s) on the drive system(s) 514 can overlap or supplement corresponding systems of the vehicle control system 502 (e.g., the sensor system(s) 506).

The drive system(s) 514 can include many of the vehicle systems, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 514 can include a drive system controller 534 which can receive and preprocess data from the sensor system(s) 506 and to control operation of the various vehicle systems. In some examples, the drive system controller can include one or more processors and memory communicatively coupled with the processor(s). The memory can store one or more modules to perform various functionalities of the drive system(s) 514. Furthermore, the drive system(s) 514 also includes one or more communication connections that enable communication by the respective drive system with one or more other local or remote computing device(s).

The computing device(s) 504 within the vehicle control system 502 can include one or more processors 516 and memory 518 communicatively coupled with the processor(s) 516. In the illustrated example, the memory 518 of the vehicle computing device(s) 504 includes log data store 520, a localization component 522, a perception component 524. The perception component 524 can include a dynamic drivable area management component 526.

The computing device(s) 504 within the vehicle control system 502 can include a prediction component 528, and a planning component 530. The planning component 530 can include a dynamic drivable area management based trajectory component 532.

The computing device(s) 504 within the vehicle control system 502 can include one or more system controllers 534. Though depicted as residing in the memory 518 for illustrative purposes, it is contemplated that the localization component 522, the perception component 524, the prediction component 528, the planning component 530, and the system controller(s) 534 can additionally, or alternatively, be accessible to the computing device(s) 504 (e.g., stored in a different component of vehicle control system 502 and/or stored remotely and accessible to the vehicle control system 502).

The log data store 520 can include map data, vehicle type, software version, vehicle positions, vehicle velocities, vehicle accelerations, or the like over time during the course of individual trips. In some examples, the log data store 520 can further include raw sensor data and/or data based on sensor data detected at the plurality of vehicles, for example, data identifying characteristics of the environment in which a vehicle was operated, objects within the proximity of the vehicle, attributes or characteristics of the environment and objects (e.g., classifications, sizes, shapes, positions, trajectories, etc.).

The localization component 522 can include functionality to receive data from the sensor system(s) 506 to determine a position of the real vehicle associated with the vehicle control system 502. For example, the localization component 522 can include and/or request/receive a three-dimensional map of the real environment and can continuously determine a location of the autonomous vehicle within the map. In some instances, the localization component 522 can use SLAM (simultaneous localization and mapping) or CLAMS (calibration, localization and mapping, simultaneously) to receive time-of-flight data, image data, lidar data, radar data, sonar data, IMU data, GPS data, wheel encoder data, or any combination thereof, and the like to accurately determine a location of the autonomous vehicle.

The perception component 524 can include functionality to perform object detection, sensor, fusion, (e.g., associating vision data, lidar data, radar data, etc. whereby the sensor data represents the same (or a portion of) an object or field of view), segmentation, and/or classification. In some examples, the perception component 524 can provide processed sensor data that indicates a presence of an entity that is proximate to the real or simulated vehicle associated with the vehicle control system 502 and/or a classification of the entity as an entity type (e.g., car, pedestrian, cyclist, building, tree, road surface, curb, sidewalk, unknown, etc.). In additional and/or alternative examples, the perception component 524 can provide processed sensor data that indicates one or more characteristics associated with a detected entity and/or the real or simulated environment in which the entity is positioned. In some examples, characteristics associated with an entity can include, but are not limited to, an x-position (global position), a y-position (global position), a z-position (global position), an orientation, an entity type (e.g., a classification), a velocity of the entity, an extent of the entity (size), etc. Characteristics associated with the environment can include, but are not limited to, a presence of another entity in the environment, a state of another entity in the environment, a time of day, a day of a week, a season, a weather condition, an indication of darkness/light, etc.

The dynamic drivable area management component 526 can be utilized to perform dynamic drivable area determining management. The dynamic drivable area management component 526 can determine, based on sensor data, one or more dynamic objects (e.g., one or more of the dynamic objects 108, 154, and 156, as discussed above with reference to FIG. 1) in the environment. The dynamic drivable area management component 526 can determine, based on the sensor data and map data, one or more top-down representations (e.g., one or more the top-down representations 114 and 162, as discussed above with reference to FIG. 1) of the environment. The top-down representation(s) 114 and/or 162 include at least road marking and velocity information associated with the dynamic object(s) 108, 154, and 156.

The top-down representation(s) 114 and/or 162 can be input into a machine learned model, which can be utilized to determine the dynamic drivable area. The machine learned model can receive one or more outputs including one or more probabilities (e.g., one or more probabilities P1 130 and P3 176) that one or more elements of the output(s) represent one or more drivable areas and outputs comprising one or more probabilities (e.g., one or more probabilities P2 132 and P4 178) that one or more elements of the output(s) represent one or more non-drivable areas. The probability(ies) P1 130 and/or P3 176 can be utilized to generate one or more trajectories based on the output(s). One or more vehicles (e.g., one or more of the vehicle(s) 106 and 152) can be controlled based on the trajectory(ies).

The prediction component 528 can receive sensor data from the sensor system(s) 506, map data, and/or perception data output from the perception component 524 (e.g., processed sensor data), and can output predictions associated with one or more objects within the environment of the autonomous vehicle. Predictions can include predicted trajectories associated with objects in the environment in which the autonomous vehicle is operating.

The planning component 530 can determine a path for the vehicle control system 502 to direct the real vehicle through a real environment. For example, the planning component 530 can determine various routes and paths and various levels of detail. In some instances, the planning component 530 can determine a route to travel from a first location (e.g., a current location) to a second location (e.g., a target location). For the purpose of this discussion, a route can be a sequence of waypoints for traveling between two locations. As non-limiting examples, waypoints include streets, intersections, global positioning system (GPS) coordinates, etc. Further, the planning component 530 can generate an instruction for guiding the autonomous vehicle along at least a portion of the route from the first location to the second location. In at least one example, the planning component 530 can determine how to guide the autonomous vehicle from a first waypoint in the sequence of waypoints to a second waypoint in the sequence of waypoints. In some examples, the instruction can be a path, or a portion of a path. In some examples, multiple paths can be substantially simultaneously generated (i.e., within technical tolerances) in accordance with a receding horizon technique. A single path of the multiple paths in a receding data horizon having the highest confidence level may be selected to operate the vehicle.

In other examples, the planning component 530 can alternatively, or additionally, use data from the perception component 524 to determine a path for the real vehicle associated with the vehicle control system 502 to follow to traverse through an environment. For example, the planning component 530 can receive data from the perception component 524 regarding objects associated with an environment. Using this data, the planning component 530 can determine a route to travel from a first location (e.g., a current location) to a second location (e.g., a target location) to avoid objects in an environment. In at least some examples, such a planning component 530 may determine there is no such collision free path and, in turn, provide a path which brings the vehicle to a safe stop avoiding all collisions and/or otherwise mitigating damage.

The dynamic drivable area management based trajectory component 532 can be managed (e.g., identified, determined, generated, modified updated, deleted, utilized, etc., or any combination thereof) to determine one or more trajectories based on one or more dynamic drivable areas. For example, the trajectory(ies) can be utilized by the planning component 530 for management of one or more the routes and paths.

In at least one example, system controller(s) 534 can be configured to control steering, propulsion, braking, safety, emitters, communication, and other systems of the vehicle control system 502. These system controller(s) 534 can communicate with and/or control corresponding systems of the drive system(s) 514 and/or other components (e.g., one or more other components of the vehicle computing device(s) 504) of the vehicle control system 502, which can be configured to operate in accordance with a path provided from the planning component 530.

The computing device(s) 538 can receive log data from the vehicle control system 502 and drive simulations based at least in part on the log data. Although not shown in this example, the computing device(s) 538 also may include log data store(s) similar or identical to the log data store 520. The computing device(s) 538 may include one or more processors 540 and memory 542 communicatively coupled with the processor(s) 540. In the illustrated example, the memory 542 of the computing device(s) 538 stores a dynamic drivable area management component 544. In some implementations, the dynamic drivable area management component 544 may be utilized to implement any of the device(s) and/or system(s) utilized to perform the dynamic drivable area management, as discussed above with reference to FIGS. 1-4.

The dynamic drivable area management component 544 can perform any functions of the dynamic drivable area management component 526, and/or vice versa. The dynamic drivable area management component 544 can perform any functions of the dynamic drivable area management based trajectory component 532, and/or vice versa. As an example, the dynamic drivable area management component 544 can be utilized to perform dynamic drivable area determining management. In the example or another example, the dynamic drivable area management component 544 can be utilized to determine one or more trajectories based on one or more dynamic drivable areas.

The processor(s) 516 of the computing device(s) 504 and the processor(s) 540 of the computing device(s) 538 can be any suitable processor capable of executing instructions to process data and perform operations as described herein. By way of example and not limitation, the processor(s) 516 and 540 can comprise one or more Central Processing Units (CPUs), Graphics Processing Units (GPUs), or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

The memory 518 of the computing device(s) 504, and the memory 542 of the computing device(s) 538 are examples of non-transitory computer-readable media. The memory 518 and 542 can store an operating system and one or more software applications, instructions, programs, and/or data to implement the methods described herein and the functions attributed to the various systems. In various implementations, the memory 518 and 542 can be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

In some instances, aspects of some or all of the components discussed herein can include any models, algorithms, and/or machine learning algorithms. For example, any or all of the components within the memory 518 and memory 542 can be implemented as a neural network.

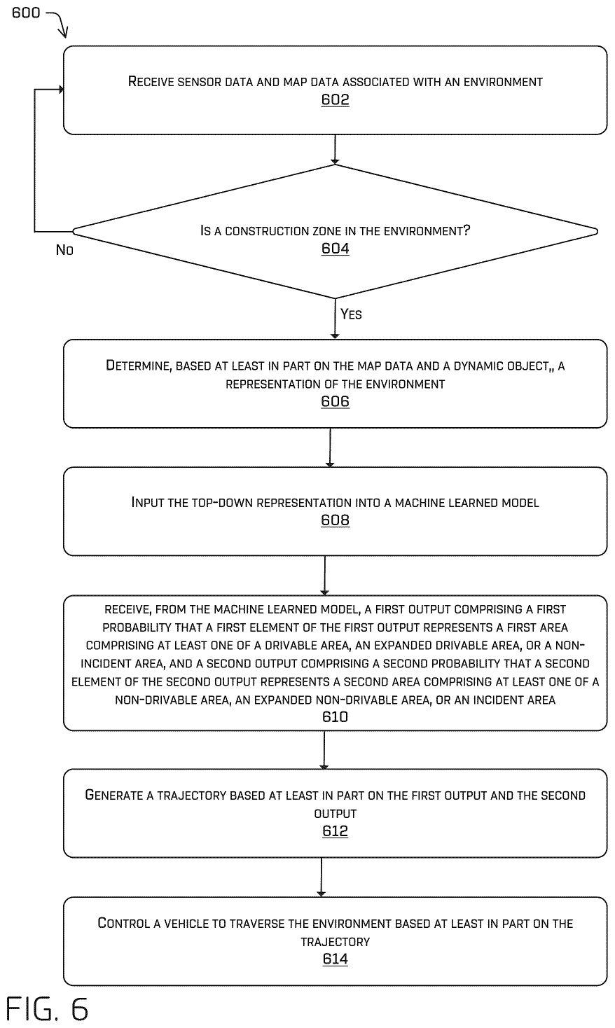

FIG. 6 depicts an example process 600 for dynamic drivable area determining management. For example, some or all of the process 600 can be performed by one or more components in FIG. 5, as described herein.

At operation 602, the process 600 may include receiving sensor data and map data associated with an environment (e.g., the environment, as discussed above with reference to FIG. 1). The sensor data may include image data (e.g., camera data) and/or depth data (e.g., lidar data).

At operation 604, the process 600 may include determining whether a construction zone is in the environment. If the construction zone is not in the environment, the process 600 may return to operation 602. If the construction zone is in the environment, the process 600 may proceed to operation 606.

At operation 606, the process may include determining, based at least in part on the map data and a dynamic object, a representation (e.g., the top-down representation 114) of the environment. The top-down representation 114 may include the construction zone 116. The operation 606 may be performed, in some cases, and in addition to or alternatively to performing the operation 602, in response to determining, based at least in part on the sensor data, the dynamic object the in the environment.

At operation 608, the process may include inputting the top-down representation 114 into a machine learned (ML) model (e.g., the machine learned (ML) model 170). The machine learned (ML) model 170 can be utilized to analyze the construction zone 116 in the top-down representation 114.

At operation 610, the process may include receiving, from the machine learned model, a first output comprising a first probability (e.g., the probability P1 122) that a first element of the first output represents a first area comprising at least one of a drivable area, an expanded drivable area, or a non-incident area, and a second output comprising a second probability (e.g., the probability P2 132) that a second element of the second output represents a second area comprising at least one of a non-drivable area, an expanded non-drivable area, or an incident area. The outputs can be received based at least in part on the analyzing of the construction zone 116.

At operation 612, the process may include, based at least in part on the outputs being received from the machine learned (ML) model, generating a trajectory (e.g., the trajectory 144). The trajectory may be generated based at least in part on the first output and the second output.

At operation 614, the process may include controlling a vehicle (e.g., the vehicle 106) to traverse the environment based at least in part on the trajectory 144. The vehicle 106 can be controlled based at least in part on the outputs, including the first output and the second output.

### EXAMPLE CLAUSES

A: A system comprising: one or more processors; and one or more non-transitory computer-readable media storing instructions executable by the one or more processors, wherein the instructions, when executed, cause the system to perform operations comprising: receiving sensor data from a sensor associated with an autonomous vehicle; receiving map data of an environment; determining, based on the sensor data, a dynamic object in the environment; determining, based on the sensor data and the map data, a top-down representation of the environment, wherein the top-down representation comprises at least road marking and velocity information associated with the dynamic object; inputting the top-down representation into a machine learned model; receiving, from the machine learned model, a first output comprising a first probability that a first element of the first output represents a drivable area and a second output comprising a second probability that a second element of the second output represents a non-drivable area; generating a trajectory based on the first output and the second output; and controlling the autonomous vehicle to traverse the environment based on the trajectory.

B: The system of paragraph A, the operations further comprising: triggering operation of the autonomous vehicle by determining that there are at least one of dividers or cones on a roadway.

C: The system of paragraph A or B, wherein the top-down representation comprises a multi-channel image or polylines.

D: The system of any of paragraphs A-C, wherein the sensor data is received from one or more of a lidar sensor, a radar sensor, or an image sensor.

E: The system of any of paragraphs A-D, further comprising: determining perception data that comprises previous road marking and velocity information, the previous road marking and velocity information comprising velocity information associated with objects in the environment; and training the machine learned model based on the perception data.

F: A method comprising: receiving sensor data and map data associated with an environment; determining, based at least in part on the sensor data, a dynamic object in the environment; determining, based at least in part on the map data and the dynamic object, a representation of the environment; inputting the representation into a machine learned model; receiving, from the machine learned model, a first output comprising a first probability that a first element of the first output represents a first area comprising at least one of a drivable area, an expanded drivable area, or a non-incident area, and a second output comprising a second probability that a second element of the second output represents a second area comprising at least one of a non-drivable area, an expanded non-drivable area, or an incident area; and generating a trajectory based at least in part on the first output and the second output; and controlling a vehicle to traverse the environment based at least in part on the trajectory.

G: The method of paragraph F, further comprising: triggering operation of the vehicle by determining that there are at least one of dividers or cones on a roadway.

H: The method of paragraph F or G, wherein the representation comprises a multi-channel image or polylines.

I: The method of any of paragraphs F-H, further comprising: determining perception data that comprises previous road marking and velocity information, the previous road marking and velocity information comprising velocity data associated with objects in the environment; and training the machine learned model based at least in part on the perception data.

J: The method of any of paragraphs F-I, further comprising: determining, by the machine learned model, to avoid following the dynamic object, based at least in part on the speed of the dynamic object being below a threshold speed; and in response to determining to avoid following the dynamic object, controlling the vehicle to not follow the dynamic object.

K: The method of any of paragraphs F-J, wherein the drivable area output by the machine learned model is different than a drivable area indicated by the map data.

L: The method of any of paragraphs F-K, further comprising: detecting one or more of traffic control indications as input to the machine learned model, the traffic control indications comprising at least one of a lanes merge ahead sign, an entering construction zone sign, a do not enter sign, a construction zone ahead sign, or a flagger sign.

M: One or more non-transitory computer-readable media storing instructions executable by one or more processors, wherein the instructions, when executed, cause the one or more processors to perform operations comprising: receiving sensor data and map data associated with an environment; determining, based at least in part on the sensor data, a dynamic object in the environment; determining, based at least in part on the map data and the dynamic object, a representation of the environment; inputting the representation into a machine learned model; receiving, from the machine learned model, a first output comprising a first probability that a first element of the first output represents a first area comprising at least one of a drivable area and a second output comprising a second probability that a second element of the second output represents a second area comprising at least one of a non-drivable area, an expanded non-drivable area, or an incident area; generating a trajectory based at least in part on the first output and the second output; and controlling a vehicle to traverse the environment based at least in part on the trajectory.

N: The one or more non-transitory computer-readable media of paragraph M, further comprising: triggering operation of the vehicle by determining that there are at least one of dividers or cones on a roadway.

O: The one or more non-transitory computer-readable media of paragraph M or N, wherein the representation comprises a multi-channel image or polylines.

P: The one or more non-transitory computer-readable media of any of paragraphs M-O, wherein the sensor data is received from one or more of a lidar sensor, a radar sensor, or an image sensor.

Q: The one or more non-transitory computer-readable media of any of paragraphs M-P, wherein the instructions, when executed, cause the one or more processors to perform further operations comprising: determining perception data that comprises previous road marking and velocity information, the previous road marking and velocity information comprising velocity data associated with objects in the environment; and training the machine learned model based at least in part on the perception data.

R: The one or more non-transitory computer-readable media of any of paragraphs M-Q, wherein the instructions, when executed, cause the one or more processors to perform further operations comprising: determining log data of another vehicle under control of a driver and traversing a construction zone; and training the machine learned model based at least in part on the log data.

S: The one or more non-transitory computer-readable media of any of paragraphs M-R, wherein the instructions, when executed, cause the one or more processors to perform further operations comprising: determining that the first probability is greater than a threshold probability and the second probability is less than the threshold probability; and generating a trajectory through the drivable area based at least in part on the first probability being greater than a threshold probability and the second probability being less than the threshold probability.

T: The one or more non-transitory computer-readable media of any of paragraphs M-S, wherein the instructions, when executed, cause the one or more processors to perform further operations comprising: receiving from the machine learned model, a boundary line associated with the drivable area, and determining the trajectory based at least in part on the boundary line.

U: A system comprising: one or more processors; and one or more non-transitory computer-readable media storing instructions executable by the one or more processors, wherein the instructions, when executed, cause the system to perform operations comprising: receiving sensor data from a sensor associated with an autonomous vehicle; receiving map data of an environment; determining, based on the sensor data, a dynamic object in the environment; determining, based on the sensor data and the map data, a representation of the environment, wherein the representation comprises at least road marking and velocity information associated with the dynamic object; inputting the representation into a machine learned model; receiving, from the machine learned model, a first output comprising a first probability that a first element of the first output represents a parking location and a second output comprising a second probability that a second element of the second output represents a non-parking location; generating a trajectory based on the first output and the second output; and controlling the autonomous vehicle to park in the parking location based on the trajectory.

V: The system of paragraph U, the operations further comprising: determining that the autonomous vehicle enters a parking destination map area; and inputting the representation into the machine learned model based at least in part on determining that the autonomous vehicle has entered the parking destination map area.

W: The system of paragraph U or V, the operations further comprising: generating dynamic map data comprising a parking destination area through which the autonomous vehicle is traversing, the dynamic map data comprising temporary data; and reverting the dynamic map data back to the map data based on at least one of i) a level of change associated with the at least road marking and velocity information being greater than a threshold level of change, or ii) a difference between an initial time at which the dynamic map data is generated and a current time being greater than a threshold difference.

X: The system of any of paragraphs U-W, the operations further comprising: generating dynamic map data comprising a parking destination area through which the autonomous vehicle is traversing, the dynamic map data comprising the map data, the first probability, and the second probability; downloading prior dynamic map data associated with a previous autonomous vehicle traversing the environment through the parking destination area; and updating the dynamic map data based on the prior dynamic map data.

Y: The system of any of paragraphs U-X, the operations further comprising: generating dynamic map data based at least in part on the first probability and the second probability, the dynamic map data comprising a first parking spot and a second parking spot; and determine to use the first parking spot based at least in part on the first parking spot being associated with a lower quality level and a higher availability level than the second parking spot, wherein controlling the autonomous vehicle further comprises controlling the autonomous vehicle to park in the parking location in response to the determining to use the first parking spot.

Z: A method comprising: receiving sensor data and map data associated with an environment; determining, based at least in part on the sensor data, a dynamic object in the environment; determining, based at least in part on the map data and the dynamic object, a representation of the environment; inputting the representation into a machine learned) model; receiving, from the machine learned model, a first output comprising a first probability that a first element of the first output represents a drivable area and a second output comprising a second probability that a second element of the second output represents a parking location; and generating a trajectory based at least in part on the first output and the second output; and controlling a vehicle to park in the parking location traverse the environment based on the trajectory.

AA: The method of paragraph Z, further comprising: determining that the autonomous vehicle enters a parking destination map area; and inputting the representation into the machine learned model based at least in part on determining that the autonomous vehicle has entered the parking destination map area.

AB: The method of paragraph Z or AA, further comprising: determining that the first probability is greater than a threshold probability and the second probability is less than the threshold probability; and generating a trajectory through the drivable area based at least in part on the first probability being greater than a threshold probability and the second probability being less than the threshold probability.

AC: The method of any of paragraphs Z-AB, further comprising: applying a threshold to the first output to identify first candidate parking locations in the environment; applying a size filter to the first candidate parking locations; and determining, based on the size filter and the first candidate parking locations, second candidate parking locations in the environment.

AD: The method of any of paragraphs Z-AC, further comprising: determining that a speed of a dynamic object is less than a threshold speed; and determining, by the machine learned model, a parking location, based at least in part on the speed of the dynamic object being below the threshold speed; and in response to determining the parking location, controlling the vehicle to park in the parking location.

AE: The method of any of paragraphs Z-AD, wherein a parking location is output by the machine learned model, and the parking location is different than an initial parking location indicated by the map data.

AF: The method of any of paragraphs Z-AE, further comprising: generating dynamic map data comprising a parking destination area through which the vehicle is traversing, the dynamic map data comprising the map data, the first probability, and the second probability; downloading prior dynamic map data associated with a previous vehicle traversing the environment through the parking destination area; and updating the dynamic map data based on the prior dynamic map data.

AG: One or more non transitory computer readable media storing instructions executable by one or more processors, wherein the instructions, when executed, cause the one or more processors to perform operations comprising: receiving sensor data and map data associated with an environment; determining, based at least in part on the sensor data, a dynamic object in the environment; determining, based at least in part on the map data and the dynamic object, a representation of the environment; inputting the representation into a machine learned (ML) model; receiving, from the machine learned (ML) model, a first output comprising a first probability that a first element of the first output represents a drivable area and a second output comprising a second probability that a second element of the second output represents a non-drivable area; generating a trajectory based at least in part on the first output and the second output; and controlling a vehicle to park in the parking location traverse the environment based on the trajectory.

AH: The one or more non transitory computer readable media of paragraph AG, further comprising: determining that the autonomous vehicle enters a parking destination map area; and inputting the representation into the machine learned model based at least in part on determining that the autonomous vehicle has entered the parking destination map area.

AI: The one or more non transitory computer readable media of paragraph AG or AH, wherein the representation comprises a top-down representation, and the top-down representation comprises a multi-channel image or polylines.

AJ: The one or more non transitory computer readable media of any of paragraphs AG-AI, wherein the sensor data is received from one or more of a lidar sensor, a radar sensor, or an image sensor.

AK: The one or more non transitory computer readable media of any of paragraphs AG-AJ, wherein the instructions, when executed, cause the one or more processors to perform further operations comprising: determining perception data that comprises previous road marking and velocity information, the previous road marking and velocity information comprising velocity data associated with objects in the environment; and training the machine learned (ML) model based at least in part on the perception data.

AL: The one or more non transitory computer readable media of any of paragraphs AG-AK, wherein the instructions, when executed, cause the one or more processors to perform further operations comprising: generating dynamic map data comprising a parking destination area through which the vehicle is traversing, the dynamic map data comprising temporary data; and reverting the dynamic map data back to the map data based on at least one of i) a level of change associated with at least road marking and velocity information being greater than a threshold level of change, or ii) a difference between an initial time at which the dynamic map data is generated and a current time being greater than a threshold difference.

AM: The one or more non transitory computer readable media of any of paragraphs AG-AL, wherein the instructions, when executed, cause the one or more processors to perform further operations comprising: determining log data of another vehicle under control of a driver and traversing a parking destination map area; and training the machine learned (ML) model based at least in part on the log data.

AN: The one or more non transitory computer readable media of any of paragraphs AG-AM, wherein the instructions, when executed, cause the one or more processors to perform further operations comprising: receiving from the machine learned (ML) model, a boundary line associated with a parking location identified by the machine learned (ML) model; and determining the trajectory based at least in part on the boundary line.

While the example clauses described above are described with respect to one particular implementation, it should be understood that, in the context of this document, the content of the example clauses can also be implemented via a method, device, system, computer-readable medium, and/or another implementation. Additionally, any of examples A-XX can be implemented alone or in combination with any other one or more of the examples A-XX.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing instructions executable by the one or more processors, wherein the instructions, when executed, cause the system to perform operations comprising:
receiving sensor data from a sensor associated with an autonomous vehicle;
receiving map data of an environment;
determining, based on the sensor data, a dynamic object in the environment;
determining, based on the sensor data and the map data, a representation of the environment, wherein the representation comprises at least road marking and velocity information associated with the dynamic object;
inputting the representation into a machine learned model;
receiving, from the machine learned model, a first output comprising a first probability that a first element of the first output represents a parking location and a second output comprising a second probability that a second element of the second output represents a non-parking location;
generating a trajectory based on the first output and the second output; and
controlling the autonomous vehicle to park in the parking location based on the trajectory.

2. The system of claim 1, the operations further comprising:
determining that the autonomous vehicle enters a parking destination map area; and
inputting the representation into the machine learned model based at least in part on determining that the autonomous vehicle has entered the parking destination map area.

3. The system of claim 1, the operations further comprising:
generating dynamic map data comprising a parking destination area through which the autonomous vehicle is traversing, the dynamic map data comprising temporary data; and
reverting the dynamic map data back to the map data based on at least one of i) a level of change associated with the at least road marking and velocity information being greater than a threshold level of change, or ii) a difference between an initial time at which the dynamic map data is generated and a current time being greater than a threshold difference.

4. The system of claim 1, the operations further comprising:
generating dynamic map data comprising a parking destination area through which the autonomous vehicle is traversing, the dynamic map data comprising the map data, the first probability, and the second probability;
downloading prior dynamic map data associated with a previous autonomous vehicle traversing the environment through the parking destination area; and
updating the dynamic map data based on the prior dynamic map data.

5. The system of claim 1, the operations further comprising:
generating dynamic map data based at least in part on the first probability and the second probability, the dynamic map data comprising a first parking spot and a second parking spot; and
determine to use the first parking spot based at least in part on the first parking spot being associated with a lower quality level and a higher availability level than the second parking spot,
wherein controlling the autonomous vehicle further comprises controlling the autonomous vehicle to park in the parking location in response to the determining to use the first parking spot.

6. A method comprising:
receiving sensor data and map data associated with an environment;
determining, based at least in part on the sensor data, a dynamic object in the environment;
determining, based at least in part on the map data and the dynamic object, a representation of the environment;
inputting the representation into a machine learned) model;
receiving, from the machine learned model, a first output comprising a first probability that a first element of the first output represents a drivable area and a second output comprising a second probability that a second element of the second output represents a parking location; and
generating a trajectory based at least in part on the first output and the second output; and
controlling a vehicle to park in the parking location traverse the environment based on the trajectory.

7. The method of claim 6, further comprising:
determining that the autonomous vehicle enters a parking destination map area; and
inputting the representation into the machine learned model based at least in part on determining that the autonomous vehicle has entered the parking destination map area.

8. The method of claim 6, further comprising:
determining that the first probability is greater than a threshold probability and the second probability is less than the threshold probability; and
generating a trajectory through the drivable area based at least in part on the first probability being greater than a threshold probability and the second probability being les s than the threshold probability.

9. The method of claim 6, further comprising:
applying a threshold to the first output to identify first candidate parking locations in the environment;
applying a size filter to the first candidate parking locations; and
determining, based on the size filter and the first candidate parking locations, second candidate parking locations in the environment.

10. The method of claim 6, further comprising:
determining that a speed of a dynamic object is less than a threshold speed; and
determining, by the machine learned model, a parking location, based at least in part on the speed of the dynamic object being below the threshold speed; and
in response to determining the parking location, controlling the vehicle to park in the parking location.

11. The method of claim 6, wherein a parking location is output by the machine learned model, and the parking location is different than an initial parking location indicated by the map data.

12. The method of claim 6, further comprising:
generating dynamic map data comprising a parking destination area through which the vehicle is traversing, the dynamic map data comprising the map data, the first probability, and the second probability;
downloading prior dynamic map data associated with a previous vehicle traversing the environment through the parking destination area; and
updating the dynamic map data based on the prior dynamic map data.

13. One or more non-transitory computer-readable media storing instructions executable by one or more processors, wherein the instructions, when executed, cause the one or more processors to perform operations comprising:
receiving sensor data and map data associated with an environment;
determining, based at least in part on the sensor data, a dynamic object in the environment;
determining, based at least in part on the map data and the dynamic object, a representation of the environment;
inputting the representation into a machine learned (ML) model;
receiving, from the machine learned (ML) model, a first output comprising a first probability that a first element of the first output represents a drivable area and a second output comprising a second probability that a second element of the second output represents a non-drivable area;
generating a trajectory based at least in part on the first output and the second output; and
controlling a vehicle to park in the parking location traverse the environment based on the trajectory.

14. The one or more non-transitory computer-readable media of claim 13, further comprising:
determining that the autonomous vehicle enters a parking destination map area; and
inputting the representation into the machine learned model based at least in part on determining that the autonomous vehicle has entered the parking destination map area.

15. The one or more non-transitory computer-readable media of claim 13, wherein the representation comprises a top-down representation, and the top-down representation comprises a multi-channel image or polylines.

16. The one or more non-transitory computer-readable media of claim 13, wherein the sensor data is received from one or more of a lidar sensor, a radar sensor, or an image sensor.

17. The one or more non-transitory computer-readable media of claim 13, wherein the instructions, when executed, cause the one or more processors to perform further operations comprising:
determining perception data that comprises previous road marking and velocity information, the previous road marking and velocity information comprising velocity data associated with objects in the environment; and
training the machine learned (ML) model based at least in part on the perception data.

18. The one or more non-transitory computer-readable media of claim 13, wherein the instructions, when executed, cause the one or more processors to perform further operations comprising:
generating dynamic map data comprising a parking destination area through which the vehicle is traversing, the dynamic map data comprising temporary data; and
reverting the dynamic map data back to the map data based on at least one of i) a level of change associated with at least road marking and velocity information being greater than a threshold level of change, or ii) a difference between an initial time at which the dynamic map data is generated and a current time being greater than a threshold difference.

19. The one or more non-transitory computer-readable media of claim 13, wherein the instructions, when executed, cause the one or more processors to perform further operations comprising:
determining log data of another vehicle under control of a driver and traversing a parking destination map area; and
training the machine learned (ML) model based at least in part on the log data.

20. The one or more non-transitory computer-readable media of claim 13, wherein the instructions, when executed, cause the one or more processors to perform further operations comprising:
receiving from the machine learned (ML) model, a boundary line associated with a parking location identified by the machine learned (ML) model; and
determining the trajectory based at least in part on the boundary line.
